(19) United States
(12) Patent Application Publication
(10) Pub. No.: US 2020/0116257 A1
(43) Pub. Date: Apr. 16, 2020

(54) CONTROL APPARATUS FOR VEHICLE DRIVE-FORCE TRANSMITTING APPARATUS

(71) Applicant: TOYOTA JIDOSHA KABUSHIKI KAISHA, Toyota-shi (JP)

(72) Inventors: Atsushi AYABE, Toyota-shi (JP); Kunio HATTORI, Nagoya-shi (JP); Asami FUJITA, Toyota-shi (JP); Yusuke OHGATA, Miyoshi-shi (JP); Shinji OITA, Toyota-shi (JP)

(73) Assignee: TOYOTA JIDOSHA KABUSHIKI KAISHA, Toyota-shi (JP)

(21) Appl. No.: 16/577,652

(22) Filed: Sep. 20, 2019

(30) Foreign Application Priority Data
Oct. 16, 2018 (JP) 2018-195438

(51) Int. Cl. F16H 61/70; F16D 21/00; F16D 41/04; F16D 41/12; F16D 48/06

(52) U.S. Cl. CPC F16H 61/702; F16D 21/00; F16D 41/04; F16D 41/12; F16D 48/06; F16D 2500/3144; F16H 37/065; F16D 2500/10493; F16D 2500/3102; F16D 2500/304; F16D 2500/30415; F16D 2500/30426; F16D 2500/52; F16D 2500/10412

(57) ABSTRACT

A control apparatus for a vehicle drive-force transmitting apparatus which defines a first drive-force transmitting path provided with a first clutch and a two-way clutch and a second drive-force transmitting path provided with a continuously variable transmission and a second clutch. The control apparatus switches the two-way clutch from its lock mode to its one-way mode, when the second drive-force transmitting path is to be established in place of the first drive-force transmitting path. In a case in which, during forward running of a vehicle with the two-way clutch being placed in the lock mode, the two-way clutch is not switched from the lock mode to the one-way mode even with a request for establishing the second drive-force transmitting path in place of the first drive-force transmitting path, the control apparatus causes the second clutch to be engaged and limits the drive force of the engine.

This application claims priority from Japanese Patent Application No. 2018-195438 filed on Oct. 16, 2018, the disclosure of which is herein incorporated by reference in its entirety.

### FIELD OF THE INVENTION

The present invention relates to a control apparatus for a drive-force transmitting apparatus that is to be provided in a vehicle, wherein the drive-force transmitting apparatus defines first and second drive-force transmitting paths that are provided in parallel with each other between an engine and drive wheels of the vehicle.

### BACKGROUND OF THE INVENTION

There is known a drive-force transmitting apparatus that is to be provided in a vehicle having an engine and drive wheels, wherein the drive-force transmitting apparatus defines first and second drive-force transmitting paths that are provided in parallel with each other between the engine and the drive wheels. The first drive-force transmitting path is provided with a first clutch and a dog clutch, and the second drive-force transmitting path is provided with a continuously variable transmission and a second clutch. For example, WO2013/176208 discloses such a drive-force transmitting apparatus. In the disclosed drive-force transmitting apparatus, the first clutch and the dog clutch are controlled to be released and the second clutch is controlled to be engaged when a first state in which a drive force of the engine is transmitted to the drive wheels along the first drive-force transmitting path is to be switched to a second state in which the drive force of the engine is transmitted to the drive wheels along the second drive-force transmitting path.

### SUMMARY OF THE INVENTION

By the way, in the drive-force transmitting apparatus disclosed in WO2013/176208, the dog clutch is provided in the first drive-force transmitting path, and is released in a running state of the vehicle that could cause the first clutch to be rotated at a high speed, for restraining the first clutch from being rotated at a high speed. However, the dog clutch is constituted to include components such as a synchromesh mechanism, thereby increasing the number of components and the cost for manufacturing the drive-force transmitting apparatus.

For the purpose of reducing the cost, the dog clutch may be replaced by a two-way clutch which is to be placed in a selected one of a plurality of operation modes that include at least an one-way mode and a lock mode, such that the two-way clutch is configured to transmit a drive force during a driving state of the vehicle and to cut off transmission of the drive force during a driven state of the vehicle when the two-way clutch is placed in the one-way mode, and such that the two-way clutch is configured to transmit the drive force during the driving state of the vehicle and during the driven state of the vehicle when the two-way clutch is placed in the lock mode. Thus, in a running state of the vehicle that could cause the first clutch to be rotated at a high speed, the two-way clutch is placed in the one-way mode whereby transmission of rotation through the two-way clutch to the first clutch is cut off, so that the first clutch can be restrained from being rotated at a high speed.

In the drive-force transmitting apparatus that is constructed as described above, when the vehicle is in the driven state (in which the vehicle is caused to run by an inertia), for example, during an inertia running of the vehicle, the two-way clutch could fail to be switched from the lock mode to the one-way mode due to members of the two-way clutch which are in contact with each other and which apply forces onto each other. If the vehicle running is continued with the two-way clutch being held in the lock mode, the rotation is transmitted to the first clutch through the two-way clutch, so that there is a risk that the first clutch could be rotated at a high speed when the running speed becomes a high speed.

The present invention was made in view of the background art described above. It is therefore an object of the present invention to provide a control apparatus for a drive-force transmitting apparatus that is to be provided in a vehicle having an engine and drive wheels, wherein the drive-force transmitting apparatus defines first and second drive-force transmitting paths that are provided in parallel with each other between the engine and the drive wheels, wherein the first drive-force transmitting path is provided with a first clutch and a two-way clutch and the second drive-force transmitting path is provided with a continuously variable transmission and a second clutch, and wherein the control apparatus is capable of restraining the first clutch from being rotated at a high speed even when the two-way clutch fails to be switched from its lock mode to its one-way mode.

The object indicated above is achieved according to the following aspects of the present invention.

According to a first aspect of the invention, there is provided a control apparatus for a drive-force transmitting apparatus that is to be provided in a vehicle having an engine and drive wheels, wherein the drive-force transmitting apparatus includes a continuously variable transmission, a first clutch, a second clutch and a third clutch, and defines first and second drive-force transmitting paths that are provided in parallel with each other between the engine and the drive wheels, such that the first clutch and the third clutch are provided in the first drive-force transmitting path, and such that the continuously variable transmission and the second clutch are provided in the second drive-force transmitting path, wherein the first drive-force transmitting path is to be established by engagement of the first clutch and release of the second clutch, such that a drive force is to be transmitted along the first drive-force transmitting path through the first clutch and the third clutch when the first drive-force transmitting path is established, wherein the second drive-force transmitting path is to be established by release of the first clutch and engagement of the second clutch, such that the drive force is to be transmitted along the second drive-force transmitting path through the continuously variable transmission and the second clutch when the second drive-force transmitting path is established, wherein the third clutch is a two-way clutch that is to be placed in a selected one of a plurality of operation modes that include at least an one-way mode and a lock mode, such that the two-way clutch is configured to transmit the drive force during a driving state of the vehicle and to cut off transmission of the drive force during a driven state of the vehicle when the two-way clutch is placed in the one-way mode, and such that the two-way clutch is configured to transmit the drive force during the driving state of the vehicle and during the driven state of the vehicle when the two-way clutch is placed in the lock mode, wherein the control apparatus includes a control portion which is configured to switch the two-way clutch from the lock mode to the one-way mode, when the second drive-force transmitting path is to be established in place of the first drive-force transmitting path, and wherein, in a case in which, during forward running of the vehicle with the two-way clutch being placed in the lock mode, the two-way clutch is not switched from the lock mode to the one-way mode even with a request for establishing the second drive-force transmitting path in place of the first drive-force transmitting path, the control portion is configured to cause the second clutch to be engaged and to limit the drive force of the engine. It is noted that the feature regarding to the two-way clutch (which is described that the two-way clutch is configured to transmit the drive force during a driving state of the vehicle and to cut off transmission of the drive force during a driven state of the vehicle when the two-way clutch is placed in the one-way mode, and the two-way clutch is configured to transmit the drive force during the driving state of the vehicle and during the driven state of the vehicle when the two-way clutch is placed in the lock mode) may be described alternatively that the two-way clutch includes an input-side rotary portion and an output-side rotary portion such that rotation is to be transmitted between the engine and the input-side rotary portion along the first drive-force transmitting path and such that rotation is to be transmitted between the output-side rotary portion and the drive wheels along the first drive-force transmitting path, wherein the input-side rotary portion is inhibited from being rotated in a predetermined one of opposite directions relative to the output-side rotary portion and is allowed to be rotated in the other of the opposite directions relative to the output-side rotary portion, when the two-way clutch is placed in the one-way mode, and wherein the input-side rotary portion is inhibited from being rotated in both of the opposite directions relative to the output-side rotary portion, when the two-way clutch is placed in the lock mode. Further, the control apparatus may further include a lock-state determining portion configured, during forward running of the vehicle, to determine whether the two-way clutch is placed in the lock mode, based on a rotational speed difference between a rotational speed of the input-side rotary portion and a rotational speed of the output-side rotary portion, wherein the lock-state determining portion is configured to determine that the two-way clutch is placed in the lock mode, when the rotational speed difference is not larger than a predetermined threshold value. Moreover, for example, the two-way clutch is provided between the first clutch and the drive wheels in the first drive-force transmitting path.

According to a second aspect of the invention, in the control apparatus according to the first aspect of the invention, the control portion is configured to control the second clutch, depending on a rotational speed difference of an actual speed value of an input-shaft rotational speed of an input shaft that is common to the first and second drive-force transmitting paths, relative to a target speed value that is a speed value of the input-shaft rotational speed of the input shaft after the second drive-force transmitting path is established in place of the first drive-force transmitting path, wherein the control portion is configured to cause the second clutch to wait to be engaged until the rotational speed difference becomes not larger than a predetermined threshold value, without causing the second clutch to be engaged until the rotational speed difference becomes not larger than the predetermined threshold value.

According to a third aspect of the invention, in the control apparatus according to the first aspect of the invention, the control portion is configured to control the second clutch, depending on a length of time from a point of time at which the request for establishing the second drive-force transmitting path in place of the first drive-force transmitting path is made, wherein the control portion is configured to cause the second clutch to wait to be engaged until the length of time becomes larger than a predetermined length value, without causing the second clutch to be engaged until the length of time becomes larger than the predetermined length value.

According to a fourth aspect of the invention, in the control apparatus according to the second or third aspect of the invention, the control portion is configured, while causing the second clutch to wait to be engaged, to cause the second clutch to start to be engaged when an accelerator pedal of the vehicle is operated.

According to a fifth aspect of the invention, in the control apparatus according to the second or third aspect of the invention, the control portion is configured, while causing the second clutch to wait to be engaged, to cause the second clutch to start to be engaged when the two-way clutch is switched from the lock mode to the one-way mode.

In the control apparatus according to the first aspect of the invention, in a case in which, during forward running of the vehicle with the two-way clutch being placed in the lock mode, the two-way clutch is not switched from the lock mode to the one-way mode even with a request for establishing the second drive-force transmitting path in place of the first drive-force transmitting path, the control portion is configured to cause the second clutch to be engaged, so that it is possible to avoid a long continuation of a neutral state of the drive-force transmitting apparatus in which transmission of the drive force is cut off, thereby reducing uncomfortable feeling that is to be given to an operator of the vehicle. Meanwhile, when the second clutch is engaged with the two-way clutch being in the lock mode, if a running speed of the vehicle is increased, rotation could be transmitted from the drive wheels to the first clutch through the two-way clutch, so that there is a risk that the first clutch could be rotated at a high speed. However, in the control apparatus according to the first aspect of the invention, the drive force of the engine is limited to limit increase of the running speed whereby the first clutch can be restrained from being rotated at a high speed.

In the control apparatus according to the second aspect of the invention, the second clutch is caused to wait to be engaged until the rotational speed difference (between the actual speed value of the input-shaft rotational speed and the target speed value of the input-shaft rotational speed) becomes not larger than the predetermined threshold value, without the second clutch being caused to be engaged until the rotational speed difference becomes not larger than the predetermined threshold value. Thus, in a case the two-way clutch is switched from the lock mode to the one-way mode while the second clutch is being caused to wait to be engaged, the rotation is not transmitted from the drive wheels to the first clutch after the engagement of the second clutch, so that the first clutch is restrained from being rotated at a high speed. Further, since the second clutch is engaged when the input-shaft rotational speed is synchronized with the target rotational speed, it is possible to reduce shock generated in process of the engagement of the second clutch.

In the control apparatus according to the third aspect of the invention, the second clutch is caused to wait to be engaged until the length of time (from the point of time at which the request for establishing the second drive-force transmitting path in place of the first drive-force transmitting path is made) becomes larger than the predetermined length value, without causing the second clutch to be engaged until the length of time becomes larger than the predetermined length value. Thus, in a case in which the two-way clutch is switched from the lock mode to the one-way mode while the second clutch is being caused to wait to be engaged, the rotation is not transmitted from the drive wheels to the first clutch after the engagement of the second clutch, so that the first clutch is restrained from being rotated at a high speed. Further, since the second clutch is engaged when the length of time (from the point of time at which the request for establishing the second drive-force transmitting path in place of the first drive-force transmitting path is made) elapses the predetermined length value, it is possible to reduce the uncomfortable feeling given to the vehicle operator, owing to the delay of the engagement of the second clutch.

In the control apparatus according to the fourth aspect of the invention, the second clutch is caused to start to be engaged, when the accelerator pedal of the vehicle is operated while the second clutch is caused to wait to be engaged. Thus, it is possible to restrain racing of the engine in the neutral state of the drive-force transmitting apparatus in which transmission of the drive force is cut off.

In the control apparatus according to the fifth aspect of the invention, the second clutch is caused to start to be engaged, when the two-way clutch is switched from the lock mode to the one-way mode while the second clutch is caused to wait to be engaged. Thus, since the two-way clutch has been already switched to the one-way mode when the second clutch is engaged, the first clutch can be restrained from being rotated at a high speed. Further, the second clutch starts to be engaged early, so that it is possible to improve responsiveness for switching to the second drive-force transmitting path.

### BRIEF DESCRIPTION OF THE DRAWINGS

FIG. 1 is a schematic view showing a construction of a vehicle to be controlled by an electronic control apparatus according to the present invention, and major control functions and control portions of the control apparatus;

FIG. 2 is a view schematically showing a construction of a two-way clutch shown in FIG. 1, wherein the view is a cross sectional view of a circumferential portion of the two-way clutch, taken in a plane perpendicular to a radial direction of the two-way clutch, and shows the two-way clutch in its one-way mode;

FIG. 3 is a view schematically showing the construction of the two-way clutch shown in FIG. 1, wherein the view is the cross sectional view of the circumferential portion, taken in the plane perpendicular to the radial direction of the two-way clutch, and shows the two-way clutch in its lock mode;

FIG. 4 is a table indicating an operation state of each of engagement devices for each of operation positions which is selected by operation of a manually-operated shifting device in the form of a shift lever that is provided in the vehicle;

FIG. 5 is a flow chart showing a main part of a control routine executed by the electronic control apparatus, namely, a control routine that is executed for restraining a first clutch from being rotated at a high speed even when the two-way clutch fails to be switched to its one-way mode; and

FIG. 6 is a time chart showing a result of the control routine executed through the control functions of the electronic control apparatus shown in FIG. 1, namely, a result of the control routine executed as shown in the flow chart of FIG. 5.

### DETAILED DESCRIPTION OF PREFERRED EMBODIMENT

Hereinafter, a preferred embodiment of the invention will be described in detail with reference to the accompanying drawings. The figures of the drawings are simplified or deformed as needed, and each portion is not necessarily precisely depicted in terms of dimension ratio, shape, etc.

### Embodiment

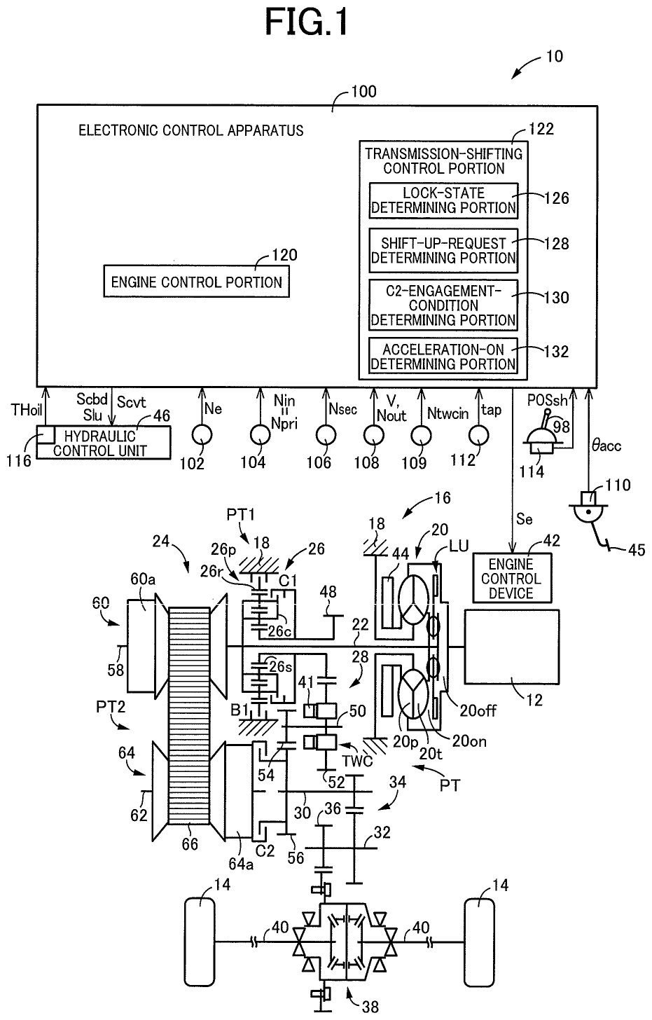

FIG. 1 is a schematic view showing a construction of a vehicle 10 to be controlled by a control apparatus according to the present invention, and major control functions and control portions of the control apparatus. As shown in FIG. 1, the vehicle 10 is provided with an engine 12 functioning as a drive force source configured to generate a drive force, drive wheels 14 and a vehicle drive-force transmitting apparatus 16 that is configured to transmit the drive force of the engine 12 to the drive wheels 14.

The drive-force transmitting apparatus 16 includes a non-rotary member in the form of a casing 18, a fluid-operated type drive-force transmitting device in the form of a known torque converter 20 that is connected to the engine 12, an input shaft 22 connected to the torque converter 20, a belt-type continuously variable transmission 24 connected to the input shaft 22, a forward/reverse switching device 26 connected to the input shaft 22, a gear mechanism 28 which is provided in parallel with the continuously variable transmission 24 and which is connected to the input shaft 22 via the forward/reverse switching device 26, an output shaft 30 serving as an output rotary member that is common to the continuously variable transmission 24 and the gear mechanism 28, a counter shaft 32, a reduction gear device 34 consisting of a pair of mutually meshing gears each of which is connected to a corresponding one of the output shaft 30 and the counter shaft 32 so as to unrotatable relative to the corresponding one of the shafts 30, 32, a gear 36 connected to the counter shaft 32 so as to be unrotatable relative to the counter shaft 32, a differential gear device 38 connected to the gear 36 in a drive-force transmittable manner, and right and left axles 40 that are connected to the differential gear device 38. The engine 12, torque converter 20, input shaft 22, continuously variable transmission 24, forward/reverse switching device 26, gear mechanism 28, output shaft 30, counter shaft 32, reduction gear device 34, gear 36 and differential gear device 38 are disposed within the casing 18.

In the drive-force transmitting apparatus 16 constructed as described above, the drive force generated by the engine 12 is transmitted to the right and left drive wheels 14, via the torque converter 20, forward/reverse switching device 26, gear mechanism 28, reduction gear device 34, differential gear device 38, axles 40 and other elements, or alternatively, via the torque converter 20, continuously variable transmission 24, reduction gear device 34, differential gear device 38, axles 40 and other elements. It is noted that the above-described drive force is synonymous with a drive torque or a drive power unless otherwise distinguished from them.

As described above, the drive-force transmitting apparatus 16 includes the gear mechanism 28 and the continuously variable transmission 24 that are provided in parallel with each other in respective drive-force transmitting paths PT between the engine 12 and the drive wheels 14. Specifically, the drive-force transmitting apparatus 16 includes the gear mechanism 28 and the continuously variable transmission 24 that are provided in parallel with each other in the respective drive-force transmitting paths PT between the input shaft 22 and the output shaft 30. That is, the drive-force transmitting apparatus 16 defines the plurality of drive-force transmitting paths that are parallel with each other between the input shaft 22 and the output shaft 30, such that the drive force of the engine 12 is to be transmitted from the input shaft 22 to the output shaft 30 through a selected one of the drive-force transmitting paths PT. The plurality of drive-force transmitting paths PT consist of a first drive-force transmitting path PT1 constituted mainly by the gear mechanism 28 and a second drive-force transmitting path PT2 constituted mainly by the continuously variable transmission 24. The first and second drive-force transmitting paths PT1, PT2 are defined in parallel with each other between the input shaft 22 and the output shaft 30. The first drive-force transmitting path PT1 is a drive-force transmitting path along which the drive force of the engine 12 is to be transmitted from the input shaft 22 toward the drive wheels 14 through the gear mechanism 28. The second drive-force transmitting path PT2 is a drive-force transmitting path along which the drive force of the engine 12 is to be transmitted from the input shaft 22 toward the drive wheels 14 through the continuously variable transmission 24. It is noted that the input shaft 22 is an input shaft that is common to the first and second transmitting paths PT1, PT2, and that the output shaft 30 is an output shaft that is common to the first and second transmitting paths PT1, PT2.

The first drive-force transmitting path PT1 is provided with: the forward/reverse switching device 26 including a first clutch C1 and a first brake B1; the gear mechanism 28; and a two-way clutch TWC serving as a third clutch, and is a drive-force transmitting path along which the drive force of the engine 12 is to be transmitted from the input shaft 22 to the drive wheels 14 through the gear mechanism 28. In the first drive-force transmitting path PT1, the forward/reverse switching device 26, gear mechanism 28 and two-way clutch TWC are arranged in this order of description in a direction away from the engine 12 toward the drive wheels 14, so that the first clutch C1 (that is included in the forward/reverse switching device 26) is located to be closer to the engine 12 than the two-way clutch TWC in the first drive-force transmitting path PT1. The second drive-force transmitting path PT2 is provided with the continuously variable transmission 24 and a second clutch C2, and is a drive-force transmitting path along which the drive force of the engine 12 is to be transmitted from the input shaft 22 to the drive wheels 14 through the continuously variable transmission 24. In the second drive-force transmitting path PT2, the continuously variable transmission 24 and second clutch C2 are arranged in this order of description in a direction away from the engine 12 toward the drive wheels 14.

The gear mechanism 28, which is provided in the first drive-force transmitting path PT1, provides a gear ratio EL (=input-shaft rotational speed Nin/output-shaft rotational speed Nout) that is higher than a highest gear ratio in the second drive-force transmitting path PT2 which corresponds to a highest gear ratio γmax of the continuously variable transmission 24. That is, the gear ratio EL of the gear mechanism 28, which may be interpreted also as a gear ratio in the first drive-force transmitting path PT1, is set to be a gear ratio that provides a lower speed than the highest gear ratio γmax, so that a gear ratio established in the second drive-force transmitting path PT2 provides a higher speed than the gear ratio EL established in the first drive-force transmitting path PT1. It is noted that the input-shaft rotational speed Nin is a rotational speed of the input shaft 22 and that the output-shaft rotational speed Nout is a rotational speed of the output shaft 30.

The continuously variable transmission 24 includes a primary shaft 58 provided to be coaxial with the input shaft 22 and connected integrally to the input shaft 22, a primary pulley 60 connected to the primary shaft 58 and having a variable effective diameter, a secondary shaft 62 provided to be coaxial with the output shaft 30, a secondary pulley 64 connected to the secondary shaft 62 and having a variable effective diameter, and a transfer element in the form of a transmission belt 66 looped over or mounted on the pulleys 60, 64. The continuously variable transmission 24 is a known belt-type continuously-variable transmission in which the drive force is transmitted owing to a friction force generated between the transmission belt 66 and each of the pulleys 60, 64, and is configured to transmit the drive force of the engine 12 toward the drive wheels 14. The primary pulley 60 includes a primary hydraulic actuator 60a by which the effective diameter of the primary pulley 60 is variable. The secondary pulley 64 includes a secondary hydraulic actuator 64a by which the effective diameter of the secondary pulley 64 is variable.

In the drive-force transmitting apparatus 16, one of the first and second drive-force transmitting paths PT1, PT2, which is selected depending on a running state of the vehicle 10, is established, and the drive force of the engine 12 is transmitted to the drive wheels 14 along the established one of the first and second drive-force transmitting paths PT1, PT2. Therefore, the drive-force transmitting apparatus 16 includes a plurality of engagement devices for selectively establishing the first and second drive-force transmitting paths PT1, PT2. The plurality of engagement devices include the above-described first clutch C1, first brake B1, second clutch C2 and two-way clutch TWC.

The first clutch C1, which is provided in the first drive-force transmitting path PT1, is an engagement device which is configured to selectively connect and disconnect the first drive-force transmitting path PT1, and which is configured, when the vehicle 10 is to run in forward direction, to enable the drive force to be transmitted along the first drive-force transmitting path PT1, by being engaged. The first brake B1, which is also provided in the first drive-force transmitting path PT1, is an engagement device which is configured to selectively connect and disconnect the first drive-force transmitting path PT1, and which is configured, when the vehicle 10 is to run in reverse direction, to enable the drive force to be transmitted along the first drive-force transmitting path PT1 by being engaged. The first drive-force transmitting path PT1 is established by engagement of either the first clutch C1 or the first brake B1.

The two-way clutch TWC, which is also provided in the first drive-force transmitting path PT1, is to be placed in a selected one of an one-way mode and a lock mode, such that the two-way clutch TWC is configured to transmit the drive force during a driving state of the vehicle 10 in the forward running and to cut off transmission of the drive force during a driven state of the vehicle 10 in the forward running when the two-way clutch TWC is placed in the one-way mode, and such that the two-way clutch TWC is configured to transmit the drive force during the driving state of the vehicle 10 and during the driven state of the vehicle 10 when the two-way clutch TWC is placed in the lock mode. For example, with the first clutch C1 being placed in the engaged state and with the two-way clutch TWC being placed in the one-way mode, the drive force is transmittable along the first drive-force transmitting path PT1 during the drive state of the vehicle 10 during which the vehicle 10 runs in forward direction by the drive force of the engine 12. That is, during the forward running of the vehicle 10, the drive force of the engine 12 is transmitted to the drive wheels 14 along the first drive-force transmitting path PT1. On the other hand, during the driven state of the vehicle 10, for example, during an inertia running of the vehicle 10, rotation transmitted from the drive wheels 14 is blocked by the of the two-way clutch TWC even when the first clutch C1 is in the engaged state. It is noted that the driving state of the vehicle 10 is a state in which a torque applied to the input shaft 22 takes a positive value so as to act on the input shaft 22 in a direction corresponding to a direction of the running of the vehicle 10, namely, practically, a state in which the vehicle 10 is driven by the drive force of the engine 12. It is further noted that the driven state of the vehicle 10 is a state in which a torque applied to the input shaft 22 takes a negative value so as to act on the input shaft 22 in a direction opposite to a direction of the running of the vehicle 10, namely, practically, a state in which the vehicle 10 is caused to run by an inertia with the engine 12 being dragged by rotation transmitted from the drive wheels 14.

Further, in a state in which the two-way clutch TWC is in the lock mode with the first clutch C1 being in the engaged state, the drive force is enabled to be transmitted through the two-way clutch TWC during the driven state of the vehicle 10 as well as during the driving state of the vehicle 10. In this state, the drive force of the engine 12 is transmitted to the drive wheels 14 along the first drive-force transmitting path PT1, and, during the driven sate of the vehicle 10 such as the inertia running, the rotation transmitted from the drive wheels 14 is transmitted to engine 12 along the first drive-force transmitting path PT1 whereby the engine 12 is dragged to generate an engine brake. Further, in a state in which the two-way clutch TWC is in the lock mode with the first brake B1 being in the engaged state, the drive force of the engine 12 is transmitted to the drive wheels 14 through the two-way clutch TWC along the first drive-force transmitting path PT1 and acts on the drive wheels 14 so as to force the drive wheels 14 to be rotated in a direction that causes the vehicle 10 to run in reverse direction. Thus, in this state, the vehicle 10 is enabled to run in the reverse direction with the drive force transmitted along the transmitting path PT1 to the drive wheels 14. The construction of the two-way clutch TWC will be described later.

The second clutch C2, which is provided in the second drive-force transmitting path PT2, is an engagement device which is configured to selectively connect and disconnect the second drive-force transmitting path PT2, and which is configured, when the vehicle 10 is to run in forward direction, to enable the drive force to be transmitted along the second drive-force transmitting path PT2, by being engaged. Each of the first clutch C1, first brake B1 and second clutch C2 is a known hydraulically-operated wet-type frictional engagement device that is to be frictionally engaged by operation of a hydraulic actuator. Each of the first clutch C1 and first brake B1 constitutes a part of the forward/reverse switching device 26.

The engine 12 is provided with an engine control device 42 including an electronic throttle device, a fuel injection device, an ignition device and other devices that are required for controlling an output of the engine 12. In the engine 12, the engine control device 42 is controlled, by an electronic control apparatus 100 (that corresponds to “control apparatus” recited in the appended claims), based on an operation amount θacc of an accelerator pedal 45 that corresponds to a required drive force of the vehicle 10 required by an operator of the vehicle 10, whereby an engine torque Te as an output of the engine 12 is controlled.

The torque converter 20 is provided between the engine 12 and each of the continuously variable transmission 24 and the forward/reverse switching device 26, and includes a pump impeller 20p and a turbine impeller 20t, such that the pump impeller 20p is connected to the engine 12 while the turbine impeller 20t is connected to the input shaft 22. The torque converter 20 is a fluid-operated type drive-force transmitting device configured to transmit the drive force of the engine 12 to the input shaft 22. The torque converter 20 is provided with a known lock-up clutch LU disposed between the pump impeller 20p and the turbine impeller 20t that serve as an input rotary member and an output rotary member of the torque converter 20, respectively, so that the pump impeller 20p and the turbine impeller 20t, namely, the engine 12 and the input shaft 22, can be directly connected to each other through the lock-up clutch LU, depending on the running state of the vehicle 10. The engine 12 and the input shaft 22 are directly connected to each other through the lock-up clutch LU, for example, when the vehicle 10 runs at a speed within a relatively high speed range.

The drive-force transmitting apparatus 16 is provided with a mechanical oil pump 44 connected to the pump impeller 20p. The oil pump 44 is to be driven by the engine 12, to supply a working fluid pressure as its original pressure to a hydraulic control unit (hydraulic control circuit) 46 that is provided in the vehicle 10, for performing a shifting control operation in the continuously-variable transmission 24, generating a belt clamping force in the continuously-variable transmission 24, switching the operation state of the lock-up clutch LU and switching the operation state of each of the above-described engagement devices between its engaged state and released state, or between its one-way mode and lock mode.

The forward/reverse switching device 26 includes a planetary gear device 26p of double-pinion type in addition to the first clutch C1 and the first brake B1. The planetary gear device 26p is a differential mechanism including three rotary elements consisting of an input element in the form of a carrier 26c, an output element in the form of a sun gear 26s and a reaction element in the form of a ring gear 26r. The carrier 26c is connected to the input shaft 22. The ring gear 26r is operatively connected to the casing 18 through the first brake B1. The sun gear 26s is disposed radially outside the input shaft 22, and is connected to a small-diameter gear 48 that is rotatable relative to the input shaft 22. The carrier 26c and the sun gear 26s are operatively connected to each other through the first clutch C1.

The gear mechanism 28 includes, in addition to the above-described small-diameter gear 48, a gear-mechanism counter shaft 50 and a large-diameter gear 52 which meshes with the small-diameter gear 48 and which is mounted on the counter shaft 50, rotatably relative to the counter shaft 50. The gear mechanism 28 further includes a counter gear 54 and an output gear 56. The counter gear 54 is mounted on the counter shaft 50, unrotatably relative to the counter shaft 50, and meshes with the output gear 56 that is mounted on the output shaft 30.

The two-way clutch TWC is provided between the large-diameter gear 52 and the counter gear 54 in an axial direction of the counter shaft 50, such that the two-way clutch TWC is located to be closer, than the first clutch C1 and the gear mechanism 28, to the drive wheels 14 in the first drive-force transmitting path PT1. The two-way clutch TWC is provided between the first clutch C1 and the drive wheels 14 in the first drive-force transmitting path PT1. The two-way clutch TWC is switchable between the one-way mode and the lock mode by operation of a hydraulic actuator 41 that is disposed to be adjacent to the two-way clutch TWC in the axial direction of the counter shaft 50, so as to be placed in a selected one of the one-way mode and the lock mode.

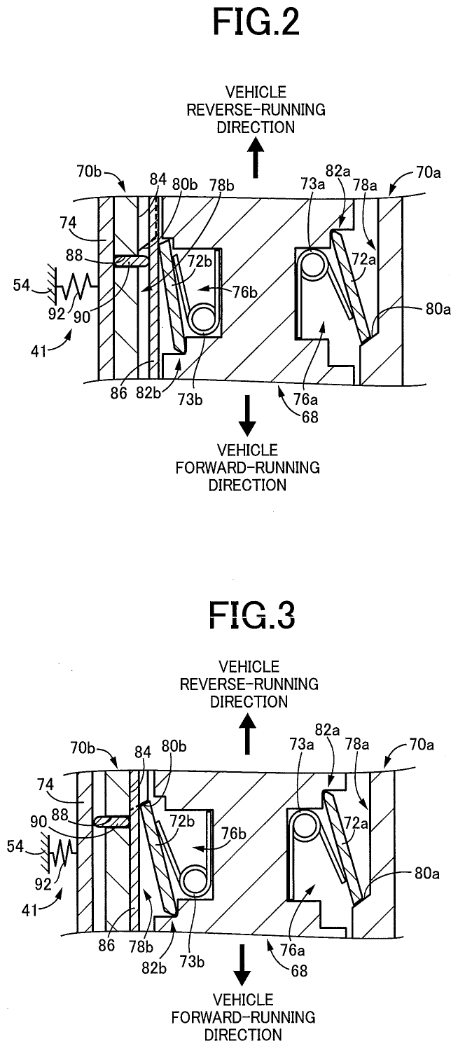

Each of FIGS. 2 and 3 is a view schematically showing a construction of the two-way clutch TWC, which enables switching between the one-way mode and the lock mode, wherein the view is a cross sectional view of a circumferential portion of the two-way clutch, taken in a plane perpendicular to a radial direction of the two-way clutch TWC. FIG. 2 shows a state in which the two-way clutch TWC is placed in the one-way mode. FIG. 3 shows a state in which the two-way clutch TWC is placed in the lock mode. In each of FIGS. 2 and 3, a vertical direction on the drawing sheet corresponds to a circumferential direction of the two-way clutch TWC, an upward direction on the drawing sheet corresponds to a vehicle reverse-running direction (i.e., direction of rotation for reverse running of the vehicle 10) and a downward direction on the drawing sheet corresponds to a vehicle forward-running direction (i.e., direction of rotation for forward running of the vehicle 10). Further, in each of FIGS. 2 and 3, a horizontal direction on the drawing sheet corresponds to the axial direction of the counter shaft 50 (hereinafter, the term “axial direction” means the axial direction of the counter shaft 50 unless otherwise specified), a rightward direction on the drawing sheet corresponds to a direction toward the large-diameter gear 52 shown in FIG. 1, and a leftward direction on the drawing sheet corresponds to a direction toward the counter gear 54 shown in FIG. 1.

The two-way clutch TWC has generally a disk shape, and is disposed radially outside the counter shaft 50. The two-way clutch TWC includes an input-side rotary member 68, first and second output-side rotary members 70a, 70b that are disposed to be adjacent to the input-side rotary member 68 so as to be located on respective opposite sides of the input-side rotary member 68 in the axial direction, a plurality of first struts 72a and a plurality of torsion coil springs 73a that are interposed between the input-side rotary member 68 and the first output-side rotary member 70a in the axial direction, and a plurality of second struts 72b and a plurality of torsion coil springs 73b that are interposed between the input-side rotary member 68 and the second output-side rotary member 70b in the axial direction. It is noted that the input-side rotary member 68 constitutes “input-side rotary portion (of the two-way clutch)” recited in the appended claims, and that the first and second output-side rotary members 70a, 70b cooperate with each other to constitute “output-side rotary portion (of the two-way clutch)” recited in the appended claims.

The input-side rotary member 68 has generally a disk shape, and is rotatable relative to the counter shaft 50 about an axis of the counter shaft 50. The input-side rotary member 68 is located between the first and second output-side rotary members 70a, 70b (hereinafter referred to as output-side rotary members 70 when they are not to be particularly distinguished from each other) in the axial direction. The input-side rotary member 68 is formed integrally with the large-diameter gear 52, such that teeth of the larger-diameter gear 52 are located radially outside the input-side rotary member 68. The input-side rotary member 68 is connected to the engine 12, in a drive-force transmittable manner, through the gear mechanism 28 and the forward/reverse switching device 26, for example.

The input-side rotary member 68 has, in its axial end surface that is opposed to the first output-side rotary member 70a in the axial direction, a plurality of first receiving portions 76a in which the first struts 72a and the torsion coil springs 73a are received. The first receiving portions 76a are equi-angularly spaced apart from each other in a circumferential direction of the input-side rotary member 68. Further, the input-side rotary member 68 has, in another axial end surface thereof that is opposed to the second output-side rotary member 70b in the axial direction, a plurality of second receiving portions 76b in which the second struts 72b and the torsion coil springs 73b are received. The second receiving portions 76b are equi-angularly spaced apart from each other in the circumferential direction of the input-side rotary member 68. The first and second receiving portions 76a are substantially aligned in a radial direction of the input-side rotary member 68.

The first output-side rotary member 70a has generally a disk-shaped, and is rotatable about the axis of the counter shaft 50. The first output-side rotary member 70a is unrotatable relative to the counter shaft 50, so as to be rotated integrally with the counter shaft 50. The first output-side rotary member 70a is connected to the drive wheels 14, in a drive-force transmittable manner, through the counter shaft 50, counter gear 54 output shaft 30 and differential gear device 38, for example.

The first output-side rotary member 70a has, in its surface that is opposed to the input-side rotary member 68 in the axial direction, a plurality of first recessed portions 78a each of which is recessed in a direction away from the input-side rotary member 68. The first recessed portions 78a, whose number is the same as the first receiving portions 76a, are equi-angularly spaced apart from each other in the circumferential direction. The first recessed portions 78a are substantially aligned with the first receiving portions 76a provided in the input-side rotary member 68, in a radial direction of the first output-side rotary member 70a. Therefore, when each of the first receiving portions 76a is aligned with one of the first recessed portions 78a in the circumferential direction, namely, when a rotational position of each of the first receiving portions 76a coincides with that of one of the first recessed portions 78a, the first receiving portion 76a and the first recessed portion 78a are opposed to and adjacent with each other in the axial direction. Each of the first recessed portions 78a has a shape by which a longitudinal end portion of any one of the first struts 72a can be received in the first recessed portion 78a. Further, each of the first recessed portions 78a has, in its circumferential end, a first wall surface 80a with which the longitudinal end portion of one of the first struts 72a is to be in contact, when the input-side rotary member 68 is rotated in the above-described vehicle forward-running direction (corresponding to the downward direction on the drawing sheet of each of FIGS. 2 and 3) relative to the output-side rotary members 70, by the drive force of the engine 12.

The second output-side rotary member 70b has generally a disk-shaped, and is rotatable about the axis of the counter shaft 50. The second output-side rotary member 70b is unrotatable relative to the counter shaft 50, so as to be rotated integrally with the counter shaft 50. The second output-side rotary member 70b is connected to the drive wheels 14, in a drive-force transmittable manner, through the counter shaft 50, counter gear 54, output shaft 30 and differential gear device 38, for example.

The second output-side rotary member 70b has, in its surface that is opposed to the input-side rotary member 68 in the axial direction, a plurality of second recessed portions 78b each of which is recessed in a direction away from the input-side rotary member 68. The second recessed portions 78b, whose number is the same as the second receiving portions 76b, are equi-angularly spaced apart from each other in the circumferential direction. The second recessed portions 78b are substantially aligned with the second receiving portions 76b provided in the input-side rotary member 68, in a radial direction of the second output-side rotary member 70b. Therefore, when each of the second receiving portions 76b is aligned with one of the second recessed portions 78b in the circumferential direction, namely, when a rotational position of each of the second receiving portions 76b coincides with that of one of the second recessed portions 78b, the second receiving portion 76b and the second recessed portion 78b are opposed to and adjacent with each other in the axial direction. Each of the second recessed portions 78b has a shape by which a longitudinal end portion of any one of the second struts 72b can be received in the second recessed portion 78b. Further, each of the second recessed portions 78b has, in its circumferential end, a second wall surface 80b with which the longitudinal end portion of one of the second struts 72b is to be in contact, when the input-side rotary member 68 is rotated in the above-described vehicle reverse-running direction (corresponding to the upward direction on the drawing sheet of each of FIGS. 2 and 3) relative to the output-side rotary members 70, by the drive force of the engine 12 with the two-way clutch TWC being placed in the lock mode, or when the vehicle 10 is in an inertia running state during the forward running with the two-way clutch TWC being placed in the lock mode.

Each of the first struts 72a is constituted by a plate-like member having a predetermined thickness, and is elongated in the circumferential direction (corresponding to the vertical direction on the drawing sheet), as shown in the cross sectional views of FIGS. 2 and 3. Further, each of the first struts 72a has a predetermined dimension as measured in a direction perpendicular to the drawing sheet of FIGS. 2 and 3.

The longitudinal end portion of each of the first struts 72a is constantly forced or biased, by a corresponding one of the torsion coil springs 73a, toward the first output-side rotary member 70a. Further, each of the first struts 72a is in contact at another longitudinal end portion thereof with a first stepped portion 82a provided in a corresponding one of the first receiving portions 76a, such that the first strut 72a is pivotable about the other longitudinal end portion thereof that is in contact with the first stepped portion 82a. Each of the torsion coil springs 73a is interposed between a corresponding one of the first struts 72a and the input-side rotary member 68, and constantly forces or biases the longitudinal end portion of the corresponding one of the first struts 72a toward the first output-side rotary member 70a.

Owing to the above-described construction, in a state in which the two-way clutch TWC is placed in either the one-way mode or the lock mode, when the input-side rotary member 68 receives the drive force which is transmitted from the engine 12 and which acts in the vehicle forward-running direction, each of the first struts 72a is in contact at the longitudinal end portion with the first wall surface 80a of the first output-side rotary member 70a and is in contact at the other longitudinal end portion with the first stepped portion 82a of the input-side rotary member 68, so that the input-side rotary member 68 and the first output-side rotary member 70a are inhibited from being rotated relative to each other whereby the drive force acting in the vehicle forward-running direction is transmitted to the drive wheels 14 through the two-way clutch TWC. The above-described first struts 72a, torsion coil springs 73a, first receiving portions 76a and first recessed portions 78a (each defining the first wall surface 80a) cooperate to constitute a one-way clutch that is configured to transmit the drive force acting in the vehicle forward-running direction, toward the drive wheels 14, and to cut off transmission of the drive force acting in the vehicle reverse-running direction, toward the drive wheels 14.

Each of the second struts 72b is constituted by a plate-like member having a predetermined thickness, and is elongated in the circumferential direction (corresponding to the vertical direction on the drawing sheet), as shown in the cross sectional views of FIGS. 2 and 3. Further, each of the second struts 72b has a predetermined dimension as measured in a direction perpendicular to the drawing sheet of FIGS. 2 and 3.

The longitudinal end portion of each of the second struts 72b is constantly forced or biased, by a corresponding one of the torsion coil springs 73b, toward the second output-side rotary member 70b. Further, each of the second struts 72b is in contact at another longitudinal end portion thereof with a second stepped portion 82b provided in one of the second receiving portions 76b, such that the second strut 72b is pivotable about the other longitudinal end portion thereof that is in contact with the second stepped portion 82b. Each of the torsion coil springs 73b is interposed between a corresponding one of the second struts 72b and the input-side rotary member 68, and constantly forces or biases the longitudinal end portion of the corresponding one of the second struts 72b toward the second output-side rotary member 70b.

Owing to the above-described construction, in a state in which the two-way clutch TWC is placed in the lock mode, when the input-side rotary member 68 receives the drive force which is transmitted from the engine 12 and which acts in the vehicle reverse-running direction, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the drive force acting in the vehicle reverse-running direction is transmitted to the drive wheels 14 through the two-way clutch TWC. Further, in the state in which the two-way clutch TWC is placed in the lock mode, when the inertia running is made during running of the vehicle 10 in the forward direction, too, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the rotation transmitted from the drive wheels 14 is transmitted toward the engine 12 through the two-way clutch TWC. The above-described second struts 72b, torsion coil springs 73b, second receiving portions 76b and second recessed portions 78b (each defining the second wall surface 80b) cooperate to constitute a one-way clutch that is configured to transmit the drive force acting in the vehicle reverse-running direction, toward the drive wheels 14, and to cut off transmission of the drive force acting in the vehicle forward-running direction, toward the drive wheels 14.

Further, the second output-side rotary member 70b has a plurality of through-holes 88 that pass through the second output-side rotary member 70b in the axial direction. Each of the through-holes 88 is located in a position that overlaps with a corresponding one of the second recessed portions 78b in the axial direction of the counter shaft 50, so that each of the through-holes 88 is in communication at its end with a corresponding one of the second recessed portions 78b. A cylindrical-shaped pin 90 is received in each of the through-holes 88, and is slidable in the through-hole 88. The pin 90 is in contact at one of its axially opposite ends with a pressing plate 74 that constitutes a part of the hydraulic actuator 41, and is in contact at the other of its axially opposite ends with an annular ring 86 that includes a plurality of portions that are located in the respective second recessed portions 78b in the circumferential direction.

The ring 86 is fitted in a plurality of arcuate-shaped grooves 84, each of which is provided in the second output-side rotary member 70b and interconnects between a corresponding adjacent pair of the second recessed portions 78b that are adjacent to each other in the circumferential direction. The ring 86 is movable relative to the second output-side rotary member 70b in the axial direction.

Like the two-way clutch TWC, the hydraulic actuator 41 is disposed on the counter shaft 50, and is located in a position adjacent to the second output-side rotary member 70b in the axial direction of the counter shaft 50. The hydraulic actuator 41 includes, in addition to the pressing plate 74, a plurality of coil springs 92 that are interposed between the counter gear 54 and the pressing plate 74 in the axial direction, and a hydraulic chamber (not shown) to which a working fluid is to be supplied whereby a thrust is generated to move the pressing plate 74 toward the counter gear 54 in the axial direction.

The pressing plate 74 has generally a disk shape, and is disposed to be movable relative to the counter shaft 50 in the axial direction. The pressing plate 74 is constantly forced or biased by the spring 92 toward the second output-side rotary member 70b in the axial direction. Therefore, in a state in which the working fluid is not supplied to the above-described hydraulic chamber of the hydraulic actuator 41, the pressing plate 74 is moved, by biasing force of the spring 92, toward the second output-side rotary member 70b in the axial direction, whereby the pressing plate 74 is in contact with the second output-side rotary member 70b, as shown in FIG. 2. In this state, the pins 90, the ring 86 and the longitudinal end portion of each of the second struts 72b are moved toward the input-side rotary member 68 in the axial direction, as shown in FIG. 2, whereby the two-way clutch TWC is placed in the one-way mode.

In a state in which the working fluid is supplied to the above-described hydraulic chamber of the hydraulic actuator 41, the pressing member 74 is moved, against the biasing force of the spring 90, toward the counter gear 54 in the axial direction, so as to be separated from the second output-side rotary member 70b. In this state, the pins 90, the ring 86 and the longitudinal end portion of each of the second struts 72b are moved, by the biasing force of the torsion coil springs 73b, toward the counter gear 54 in the axial direction, as shown in FIG. 3, whereby the two-way clutch TWC is placed in the lock mode.

In the state in which the two-way clutch TWC is placed in the one-way mode, as shown in FIG. 2, the pressing plate 74 is in contact with the second output-side rotary member 70b by the biasing force of the spring 92. In this state, the pins 90 are forced, by the pressing plate 74, to be moved toward the input-side rotary member 68 in the axial direction, and the ring 86 is forced, by the pins 90, to be moved toward the input-side rotary member 68 in the axial direction. Consequently, the longitudinal end portion of each of the second struts 72b is forced, by the ring 86, to be moved toward the input-side rotary member 68, so as to be blocked from being in contact with the second wall surface 80b, whereby the input-side rotary member 68 and the second output-side rotary member 70b are allowed to be rotated relative to each other so that the second struts 72b do not serve as a one-way clutch. Meanwhile, the longitudinal end portion of each of the first struts 72a is biased, by the corresponding coil spring 73a, toward the first output-side rotary member 70a, whereby the longitudinal end portion of each of the first struts 72a can be bought into contact with the first wall surface 80a of any one of the first recessed portions 78a so that the first struts 72a serve as a one-way clutch configured to transmit the drive force acting in the vehicle forward-running direction.

In the state in which the two-way clutch TWC is placed in the one-way mode, as shown in FIG. 2, the longitudinal end portion of each of the first struts 72a can be brought into contact with the first wall surface 80a of the first output-side rotary member 70a. Therefore, in the state of the one-way mode of the two-way clutch TWC, when the vehicle 10 is placed in the driving state in which the drive force acting in the vehicle forward-running direction is transmitted from the engine 12 to the two-way clutch TWC, the longitudinal end portion of each of the first struts 72a is in contact with the first wall surface 80a and the other longitudinal end portion of each of the first struts 72a is in contact with the first stepped portion 82a, so that the input-side rotary member 68 is inhibited from being rotated relative to the first output-side rotary member 70a in the vehicle forward-running direction whereby the drive force of the engine 12 is transmitted to the drive wheels 14 through the two-way clutch TWC. On the other hand, in the state of the one-way mode of the two-way clutch TWC, when the vehicle 10 is placed in the driven state by inertia running during the forward running, the input-side rotary member 68 is allowed to be rotated relative to the first output-side rotary member 70a in the vehicle reverse-running direction, without the longitudinal end portion of each of the first struts 72a being in contact with the first wall surface 80a, whereby the transmission of the drive force through the two-way clutch TWC is blocked. Thus, in the state in which the two-way clutch TWC is placed in the one-way mode, the first struts 72a serve as a one-way clutch which is configured to transmit the drive force in the driving state of the vehicle 10 in which the drive force acting in the vehicle forward-running direction is transmitted from the engine 12, and which is configured to block transmission of the drive force in the driven state of the vehicle 10 which is placed by inertia running during the forward running. In other words, the input-side rotary member 68 as the input-side rotary portion is inhibited from being rotated in the vehicle forward-running direction (as a predetermined one of opposite directions) relative to the output-side rotary members 70 as the output-side rotary portion, and is allowed to be rotated in the vehicle reverse-running direction (as the other of the opposite directions) relative to the output-side rotary members 70 as the output-side rotary portion, when the two-way clutch TWC is placed in the one-way mode.

In the state in which the two-way clutch TWC is placed in the lock mode, as shown in FIG. 3, the working fluid is supplied to the hydraulic chamber of the hydraulic actuator 41 whereby the pressing plate 74 is moved, against the spring 92, in a direction away from the second output-side rotary member 70b, and the longitudinal end portion of each second strut 72b is moved, by biasing force of the corresponding torsion coil spring 73b, toward the corresponding second recessed portion 78b of the second output-side rotary member 70b, whereby the longitudinal end portion of each second strut 72b can be brought into contact with the second wall surface 80b of the second output-side rotary member 70b. Meanwhile, each first strut 72a can be brought into contact at the longitudinal end portion with the first wall surface 80a of the first output-side rotary member 70a, as in the state of the one-way mode shown in FIG. 2.

In the state in which the two-way clutch TWC is placed in the lock mode, as shown in FIG. 3, when the drive force acting in the vehicle forward-running direction is transmitted to the input-side rotary member 68, the longitudinal end portion of each first strut 72a is brought into contact with the first wall surface 80a of the first output-side rotary member 70a, and the other longitudinal end portion of each first strut 72a is brought into contact with the first stepped portion 82a of the input-side rotary member 68, whereby the input-side rotary member 68 is inhibited from being rotated relative to the first output-side rotary member 70a in the vehicle forward-running direction. In the state of the lock mode of the two-way clutch TWC, when the drive force acting in the vehicle reverse-running direction is transmitted to the input-side rotary member 68, the longitudinal end portion of each second strut 72b is brought into contact with the second wall surface 80b of the second output-side rotary member 70b, and the other longitudinal end portion of each second strut 72b is brought into contact with the second stepped portion 82b of the input-side rotary member 68, whereby the input-side rotary member 68 is inhibited from being rotated relative to the second output-side rotary member 70b in the vehicle reverse-running direction. Thus, in the state of the lock mode of the two-way clutch TWC, the first struts 72a serve as a one-way clutch and the second struts 72b serve as a one-way clutch, so that the two-way clutch TWC is configured to transmit the drive force acting in the vehicle forward-running direction and the drive force acting in the vehicle reverse-running direction. In other words, the input-side rotary member 68 as the input-side rotary portion is inhibited from being rotated in both of the opposite directions relative to the output-side rotary members 70 as the output-side rotary portion, when the two-way clutch TWC is placed in the lock mode. When the vehicle 10 is to run in reverse direction, the vehicle 10 is enabled to run in reverse direction with the two-way clutch TWC being placed in the lock mode. Further, when the vehicle 10 is placed in the driven state by inertia running during the forward running, an engine brake can be generated with the two-way clutch TWC being placed in the lock mode by which the engine 12 is dragged by rotation transmitted from the drive wheels 14 to the engine 12 through the two-way clutch TWC. Thus, in the state of the lock mode of the two-way clutch TWC, the first struts 72a serve as a one-way clutch and the second struts 72b serve as a one-way clutch, so that the two-way clutch TWC is configured to transmit the drive force during the driving state and the driven state of the vehicle 10.

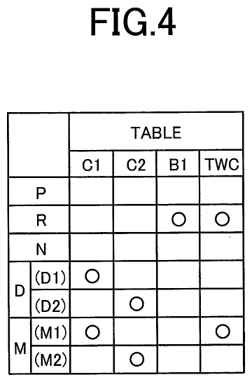

FIG. 4 is a table indicating an operation state of each of the engagement devices for each of a plurality of operation positions POSsh which is selected by operation of a manually-operated shifting device in the form of a shift lever 98 that is provided in the vehicle 10. In FIG. 4, “C1” represents the first clutch C1, “C2” represents the second clutch C2, “B1” represents the first brake B1, and “TWC” represents the two-way clutch TWC. Further, “P”, “R”, “N”, “D” and “M” represent a a parking position P, a reverse position R, a neutral position N, a drive position D and a manual position M, respectively, as the plurality of operation positions POSsh, each of which is to be selected by operation of the shift lever 98. In the table of FIG. 4, “O” in the first clutch C1, second clutch C2 or first brake B1 indicates its engaged state, and blank in the first clutch C1, second clutch C2 or first brake B1 indicates its released state. Further, in the table of FIG. 4, “O” in the two-way clutch TWC indicates its lock mode, and blank in the two-way clutch TWC indicates its one-way mode.

For example, when the shift lever 98 is placed in the parking position P as one of the operating positions POSsh that is a vehicle stop position or in the neutral position N as one of the operating positions POSsh that is a drive-force transmission block position, the first clutch C1, second clutch C2 and first brake B1 are placed in the released positions, as indicated in FIG. 4, so that the drive-force transmitting apparatus 16 is placed in its neutral state in which the drive force is not transmitted along either the first drive-force transmitting path PT1 or the second drive-force transmitting path PT2.

When the shift lever 98 is placed in the reverse position R as one of the operating positions POSsh that is a reverse running position, the first brake B1 is placed in the engaged state and the two-way clutch TWC is placed in the lock mode, as indicated in FIG. 4. With the first brake B1 being placed in the engaged state, the drive force acting in the vehicle reverse-running direction is transmitted from the engine 12 to the gear mechanism 28. In this instance, if the two-way clutch TWC is in the one-way mode, the drive force is blocked by the two-way clutch TWC so that reverse running cannot be made. Thus, with the two-way clutch TWC being placed in the lock mode, the drive force acting in the vehicle reverse-running direction is transmitted to the output shaft 30 through the two-way clutch TWC so that reverse running can be made. When the shift lever 98 is placed in the reverse position R, the first brake B1 is placed in the engaged state and the two-way clutch TWC is placed in the lock mode, whereby a reverse gear position is established to transmit the drive force acting in the vehicle reverse-running direction, through the gear mechanism 28 along the first drive-force transmitting path PT1, to the drive wheels 14.

When the shift lever 98 is placed in the drive position D as one of the operating positions POSsh that is a forward running position, the first clutch C1 is placed in the engaged state or the second clutch C2 is placed in the engaged state, as indicated in FIG. 4. In FIG. 4, “D1” and “D2” represent a drive position D1 and a drive position D2, respectively, which are operating positions virtually set in control. When the shift lever 98 is placed in the drive position D, one of the drive position D1 and the drive position D2 is selected depending a running state of the vehicle 10, and the selected one is automatically established. The drive position D1 is established when the vehicle running speed is within a relatively low speed range including zero speed (vehicle stop). The drive position D2 is established when the vehicle running speed is within a relatively high speed range including a middle speed range. For example, during running of the vehicle 10 with the shift lever 98 being placed in the drive position D, when the running state of the vehicle 10 is changed from the low speed range to the high speed range, the drive position D1 is automatically switched to the drive position D2.

For example, when the running state of the vehicle 10 is in a speed range corresponding to the drive position D1 upon placement of the shift lever 98 into the drive position D, the first clutch C1 is engaged and the second clutch C2 is released. In this case, a gear running mode is established whereby the drive force acting in the vehicle forward-running direction is transmitted from the engine 12 to the drive wheels 14 along the first drive-force transmitting path PT1 through the gear mechanism 28. The two-way clutch TWC, which is placed in the one-way mode, transmits the drive force acting in the vehicle forward-running direction.

Further, when the running state of the vehicle 10 is in a speed range corresponding to the drive position D2 upon placement of the shift lever 98 into the drive position D, the first clutch C1 is released and the second clutch C2 is engaged. In this case, a belt running mode is established whereby the drive force acting in the vehicle forward-running direction is transmitted from the engine 12 to the drive wheels 14 along the second drive-force transmitting path PT2 through the continuously variable transmission 24. Thus, when the shift lever 98 is placed into the drive position D as one of the operating positions POSsh, the drive force of the engine 12 is transmitted to the drive wheels 14 along a selected one of the first and second drive-force transmitting paths PT1, PT2, which is selected depending on the running state of the vehicle 10.

When the shift lever 98 is placed in the manual position M as one of the operating positions POSsh, a shift-up operation or a shift-down operation can be executed by a manual operation made by an operator of the vehicle 10. That is, the manual position M is a manual shift position in which a shifting operation can be made by the manual operation made by the operator. For example, when a shift-down operation is manually made by the operator with the shift lever 98 being placed in the manual position M, the first clutch C1 is placed into the engaged state and the two-way clutch TWC is placed into the lock mode whereby a forward-running gear position is established. With the two-way clutch TWC being placed in the lock mode, the drive force can be transmitted through the two-way clutch TWC during the driven state of the vehicle 10 as well as during the driving state of the vehicle 10. During the inertia running, for example, the vehicle 10 is placed in the driven state in which the rotation is transmitted from the drive wheels 14 toward the engine 12. In the driven state, when the shift-down operation is manually executed with the shift lever 98 being placed in the manual position M, the rotation transmitted from the drive wheels 14 is transmitted toward the engine 12 through the two-way clutch TWC that is placed in the lock mode, whereby the engine 12 is dragged to generate an engine brake. Thus, when the shift-down operation is executed with the shift lever 98 being placed in the manual position M, the forward-running gear position is established so that the drive force is transmitted to the drive wheels 14 along the first drive-force transmitting path PT1 through the gear mechanism 28, and so that the rotation transmitted from the drive wheels 14 is transmitted toward the engine 12 along the first drive-force transmitting path PT1 so as to generate the engine brake during the inertia running.

When a shift-up operation is manually made by the operator with the shift lever 98 being placed in the manual position M, the second clutch C2 is placed into the engaged state whereby a forward-running continuously-variable shifting position is established so that the drive force is transmitted to the drive wheels 14 along the second drive-force transmitting path PT2 through the continuously variable transmission 24. Thus, with the shift lever 98 being placed in the manual position M, a manual shifting can be executed by manual operation made by the operator, to select one of the forward-running gear position and the forward-running continuously-variable shifting position. When the forward-running gear position, i.e., the gear running mode, is selected, the drive force can be transmitted along the first drive-force transmitting path PT1. When the forward-running continuously-variable shifting position, i.e., the belt running mode, is selected, the drive force can be transmitted along the second drive-force transmitting path PT2. The case in which the shift-down operation has been made with the shift lever 98 being placed in the manual position M, corresponds to “M1” (position M1) that is shown in FIG. 4. The case in which the shift-up operation has been made with the shift lever 98 being placed in the manual position M, corresponds to “M2” (position M2) that is shown in FIG. 4. Although the positions M1, M2 do not exist in appearance, for the purpose of convenience in the following description, it will be described that “the position M1 is established” when the shift-down operation has been manually made with the shift lever 98 being placed in the manual position M, and it will be described that “the position M2 is established” when the shift-up operation has been manually made with the shift lever 98 being placed in the manual position M.

Referring back to FIG. 1, the vehicle 10 is provided with the electronic control apparatus 100 as a controller including the control apparatus constructed according to present invention. For example, the electronic control apparatus 100 includes a so-called microcomputer incorporating a CPU, a ROM, a RAM and an input-output interface. The CPU performs control operations of the vehicle 10, by processing various input signals, according to control programs stored in the ROM, while utilizing a temporary data storage function of the RAM. The electronic control apparatus 100 is configured to perform, for example, an engine control operation for controlling an output of the engine 12, a shifting control operation and a belt-clamping-force control operation for the continuously-variable transmission 24, and a hydraulic-pressure control operation for switching the operation state of each of the plurality of engagement devices (C1, B1, C2, TWC). The electronic control apparatus 100 may be constituted by two or more control units exclusively assigned to perform different control operations such as the engine control operation and the hydraulic-pressure control operation.

The electronic control apparatus 100 receives various input signals based on values detected by respective sensors provided in the vehicle 10. Specifically, the electronic control apparatus 100 receives: an output signal of an engine speed sensor 102 indicative of an engine rotational speed Ne which is a rotational speed of the engine 12; an output signal of a primary speed sensor 104 indicative of a primary rotational speed Npri which is a rotational speed of the primary shaft 58 which is equivalent to an input-shaft rotational speed Nin; an output signal of a secondary speed sensor 106 indicative of a secondary rotational speed Nsec which is a rotational speed of the secondary shaft 62; an output signal of an output speed sensor 108 indicative of an output-shaft rotational speed Nout which is a rotational speed of the output shaft 30 and which corresponds to the running speed V of the vehicle 10; an output signal of an input speed sensor 109 indicative of an input rotational speed Ntwcin which is a rotational speed of the input-side rotary member 68 of the two-way clutch TWC; an output signal of an accelerator-operation amount sensor 110 indicative of the above-described operation amount θacc of the accelerator pedal 45 which represents an amount of accelerating operation made by the vehicle operator; an output signal of a throttle-opening degree sensor 112 indicative of the throttle opening degree tap; an output signal of a shift position sensor 114 indicative of an operation position POSsh of a manually-operated shifting device in the form of the shift lever 98 provided in the vehicle 10; and an output signal of a temperature sensor 116 indicative of a working fluid temperature THoil that is a temperature of a working fluid in the hydraulic control unit 46. It is noted that the input-shaft rotational speed Nin (=primary rotational speed Npri) is equivalent to a rotational speed of the turbine impeller 20t of the of the torque converter 20. Further, the electronic control apparatus 100 calculates an actual gear ratio γcvt (=Npri/Nsec) that is an actual value of the gear ratio γcvt of the continuously-variable transmission 24, based on the primary rotational speed Npri and the secondary rotational speed Nsec. Moreover, the electronic control apparatus 100 calculates an output rotational speed Ntwcout of the first and second output-side rotary members 70a, 70b of the two-way clutch TWC, based on the output-shaft rotational speed Nout.

Further, the electronic control apparatus 100 generates various output signals which are supplied to various devices such as the engine control device 42 and the hydraulic control unit 46 and which include an engine-control command signal Se for controlling the engine 12, a hydraulic control command signal Scvt for performing hydraulic controls such as controls of the shifting action and the belt clamping force of the continuously-variable transmission 24, a hydraulic-control command signal Scbd for performing hydraulic controls of operation states of the plurality of engagement devices, and a hydraulic-control command signal Slu for performing hydraulic controls of an operation state of the lock-up clutch LU.

The hydraulic control unit 46, which receives the above-described hydraulic control command signals, outputs a SL1 pressure Psl1 that is supplied to a hydraulic actuator of the first clutch C1, a B1 control pressure Pb1 that is supplied to a hydraulic actuator of the first brake B1, a SL2 pressure Psl2 that is supplied to a hydraulic actuator of the second clutch C2, a TWC pressure Ptwc that is supplied to the hydraulic actuator 41 configured to switch the two-way clutch TWC between the one-way mode and the lock mode, a primary pressure Ppri that is supplied to the hydraulic actuator 60a of the primary pulley 60, a secondary pressure Psec that is supplied to the hydraulic actuator 64a of the secondary pulley 64, and a LU pressure Plu that is supplied for controlling the lock-up clutch LU. It is noted that each of the SL1 pressure Psl1, SL2 pressure Psl2, B1 control pressure Pb1, TWC pressure Ptwc, primary pressure Ppri, secondary pressure Psec and LU pressure Plu is regulated directly or indirectly by an electromagnetic valve (not shown) that is provided in the hydraulic control unit 46.

For performing various control operations in the vehicle 10, the electronic control apparatus 100 includes an engine control means or portion in the form of an engine control portion 120 and a transmission shifting control means or portion in the form of a transmission-shifting control portion 122.

The engine control portion 120 calculates a required drive force Fdem, for example, by applying the accelerator operation amount θacc and the running velocity V to a predetermined or stored relationship (e.g., drive force map) that is obtained by experimentation or determined by an appropriate design theory. The engine control portion 120 sets a target engine torque Tet that ensures the required drive force Fdem, and outputs the engine-control command signal Se for controlling the engine 12 so as to obtain the target engine torque Tet. The outputted engine-control command signal Se is supplied to the engine control device 42.

When the shift lever 98 is switched from the parking position P or the neutral position N to the drive position D during stop of the vehicle 10, for example, the transmission-shifting control portion 122 supplies, to the hydraulic control unit 46, the hydraulic-control command signal Scbd requesting engagement of the first clutch C1, whereby the forward gear running mode is established to enable forward running of the vehicle 10 by the drive force transmitted along the first drive-force transmitting path PT1. When the shift lever 98 is switched from the parking position P or the neutral position N to the reverse position R during stop of the vehicle 10, the transmission-shifting control portion 122 supplies, to the hydraulic control unit 46, the hydraulic-control command signal Scbd requesting engagement of the first brake B1 and switching of the two-way clutch TWC to the lock mode, whereby the reverse gear running mode is established to enable reverse running of the vehicle 10 by the drive force transmitted along the first drive-force transmitting path PT1.

During running of the vehicle 10 in the belt running mode by the drive force with the drive force transmitted along the second drive-force transmitting path PT2, for example, the transmission-shifting control portion 122 outputs the hydraulic control command signal Scvt by which the gear ratio γ of the continuously variable transmission 24 is controlled to a target gear ratio γtgt that is calculated based on, for example, the accelerator operation amount θacc and the vehicle running speed V. Specifically, the transmission-shifting control portion 122 stores therein a predetermined relationship (e.g., shifting map) which assures an appropriately adjusted belt clamping force in the continuously variable transmission 24 and which establishes the target gear ratio γtgt of the continuously variable transmission 24 that enables the engine 12 to be operated at an operating point lying on an optimum line (e.g., engine optimum-fuel-efficiency line). The transmission-shifting control portion 122 determines a target primary pressure Ppritgt as a command value of the primary pressure Ppri that is to be supplied to the hydraulic actuator 60a of the primary pulley 60 and a target secondary pressure Psectgt as a command value of the secondary pressure Psec that is to be supplied to the hydraulic actuator 64a of the secondary pulley 64, in accordance with the above-described stored relationship, based on the accelerator operation amount θacc and the vehicle running speed V. Thus, the transmission-shifting control portion 122 executes a shifting control of the continuously variable transmission 24, by supplying, to the hydraulic control unit 46, the hydraulic control command signal Scvt by which the primary pressure Ppri and the secondary pressure Psec are to be controlled to the target primary pressure Ppritgt and the target secondary pressure Psectgt, respectively. It is noted that the shifting control of the continuously variable transmission 24, which is a known technique, will not be described in detail.

Further, when the shift lever 98 is placed in the drive position D, the transmission-shifting control portion 122 executes a switching control operation for switching the running mode between the gear running mode and the belt running mode. Specifically, the transmission-shifting control portion 122 stores therein a predetermined relationship in the form of a shifting map for shifting from one of first and second speed positions to the other, wherein the first speed position corresponds the gear ratio EL of the gear mechanism 28 in the gear running mode, and the second speed position corresponds to the highest gear ratio γmax of the continuously variable transmission 24 in the belt running mode. In the shifting map, which is constituted by, for example, the running speed V and the accelerator operation amount θacc, a shift-up line is provided for determining whether a shift-up action to the second speed position, namely, switching to the belt running mode is to be executed or not, and a shift-down line is provided for determining whether a shift-down action to the first speed position, namely, switching to the gear running mode is to be executed or not. The transmission-shifting control portion 122 determines whether the shift-up action or shift-down action is to be executed or not, by applying actual values of the running speed V and the accelerator operation amount θacc to the shifting map, and executes the shift-up action or shift-down action (namely, switches the running mode), depending on result of the determination. For example, when a running state point, which is defined by a combination of the actual values of the running speed V and the accelerator operation amount θacc, is moved across the shift-down line in the shifting map during the running in the belt running mode, for example, it is determined that there is a request (i.e., shift-down request) requesting the shift-down action to the first speed position, namely, there is a request for the switching to the gear running mode. When the running state point is moved across the shift-up line in the shifting map during the running in the gear running mode, for example, it is determined that there is a request (i.e., shift-up request) requesting the shift-up action to the second speed position, namely, there is a request for the switching to the belt running mode. It is noted that the gear running mode corresponds to “D1” (drive position D1) shown in FIG. 4 and that the belt running mode corresponds to “D2” (drive position D2) shown in FIG. 4.

For example, during the running in the belt running mode (corresponding to the drive position D2) with the shift lever 98 being placed in the drive position D, when determining that the request for the shift-down action to the first speed position, i.e., the switching to the gear running mode, is issued or made, the transmission-shifting control portion 122 outputs, to the hydraulic control unit 46, a command requesting engagement of the first clutch C1 and release of the second clutch C2, whereby the first drive-force transmitting path PT1 is established in place of the second drive-force transmitting path PT2 so that the drive force can be transmitted along the first drive-force transmitting path PT1 in the drive-force transmitting apparatus 16. Thus, the transmission-shifting control portion 122 switches from the belt running mode (in which the drive force is to be transmitted along the second drive-force transmitting path PT2) to the gear running mode (in which the drive force is to be transmitted along the first drive-force transmitting path PT1), by a stepped shifting control (shift-down control) by which the first clutch C1 is engaged and the second clutch C2 is released.

Further, during the running in the gear running mode (corresponding to the drive position D1) with the shift lever 98 being placed in the drive position D, when determining that the request for the shift-up action to the second speed position, i.e., the switching to the belt running mode, is issued or made, the transmission-shifting control portion 122 outputs, to the hydraulic control unit 46, a command requesting release of the first clutch C1 and engagement of the second clutch C2, whereby the second drive-force transmitting path PT2 is established in place of the first drive-force transmitting path PT1 so that the drive force can be transmitted along the second drive-force transmitting path PT2 in the drive-force transmitting apparatus 16. Thus, the transmission-shifting control portion 122 switches from the gear running mode (in which the drive force is to be transmitted along the first drive-force transmitting path PT1) to the belt running mode (in which the drive force is to be transmitted along the second drive-force transmitting path PT2), by a stepped shifting control (shift-up control) by which the first clutch C1 is released and the second clutch C2 is engaged.

With the running mode of the vehicle 10 being switched to the belt running mode, the drive force is transmitted along the second drive-force transmitting path PT2 through the continuously variable transmission 24 in the drive-force transmitting apparatus 16. In this instance, the rotation of the drive wheels 14 is transmitted to the counter gear 54 through the differential gear device 38, reduction gear device 34 and output gear 56, for example, but the rotation of the counter gear 54 is blocked by the two-way clutch TWC that is placed in the one-way mode and is not transmitted to the gear mechanism 28. Therefore, even if the running speed V becomes high, it is possible to restrain the gear mechanism 28 and the first clutch C1 (more precisely, a drum or other components of the first clutch C1 that are connected to the two-way clutch TWC) from being rotated at a high speed, because the rotation of the drive wheels 14 is not transmitted to the gear mechanism 28.

By the way, during the running with the position M1 being established, the two-way clutch TWC is placed in the lock mode. Further, the vehicle 10 is placed in the driven state to be caused to run by an inertia, when the vehicle 10 is in an inertia running state. During the driven state of the vehicle 10, when the position M1 is switched to, for example, the position M2, control operations are executed to establish the second drive-force transmitting path PT2 in place of the first drive-force transmitting path PT1 and to switch the two-way clutch TWC the lock mode to the one-way mode. Specifically, a TWC pressure Ptwc, which is supplied to the hydraulic actuator 41 configured to control the operation of the two-way clutch TWC, is controlled to zero. In this instance, during the driven state of the vehicle 10, the longitudinal end portion of each of the second struts 72b and the second wall surface 80b of the second output-side rotary member 70b apply forces onto each other, and their mutual contact is not easily released, so that the two-way clutch TWC could fail to be switched from the lock mode to the one-way mode. Further, if the vehicle running is continued with the two-way clutch TWC being held in the lock mode, namely, without the switching of the two-way clutch TWC to the one-way mode, the rotation of the drive wheels 14 is transmitted to the first clutch C1 through the two-way clutch TWC, so that there is a risk that the first clutch C1 (precisely, the drum or other components of the first clutch C1 that are connected to the two-way clutch TWC) could be rotated at a high speed when the running speed V becomes a high speed.

To solve the above-described issue, in the present embodiment, the electronic control apparatus 100 is provided with a function of engaging the second clutch C2 and limiting the drive force of the engine 12 in a case in which the two-way clutch TWC is not placed into the one-way clutch even after the request for establishing the second drive-force transmitting path PT2 in place of the switching from the first drive-force transmitting path PT1 is made during the forward running with the two-way clutch TWC being placed in the lock mode. Hereinafter, there will be described control operations that are to be executed when the request for establishing the second drive-force transmitting path PT2 in place of the first drive-force transmitting path PT1 is made during the running with the two-way clutch TWC being placed in the lock mode.

For executing the above-described control operations, the transmission-shifting control portion 122 includes a lock-state determining means or portion in the form of a lock-state determining portion 126, a shift-up determining means or portion in the form of a shift-up-request determining portion 128, a C2-engagement determining means or portion in the form of a C2-engagement-condition determining portion 130, and an acceleration-ON determining means or portion in the form of an acceleration-ON determining portion 132. It is noted that the engine control portion 120 and the transmission-shifting control portion 122 cooperate with each other to constitute “control portion” recited in the appended claims.

During the forward running, the lock-state determining portion 126 determines whether the two-way clutch TWC is placed in the lock mode, by determining whether a rotational speed difference ΔNtwc is equal to or smaller than a lock-mode determination threshold value α1. The rotational speed difference ΔNtwc is a difference (=|Ntwcout−Ntwcin|) between an output rotational speed Ntwcout of the output-side rotary members 70 of the two-way clutch TWC and the input rotational speed Ntwcin of the input-side rotary member 68 of the two-way clutch TWC. The lock-mode determination threshold value α1 is a predetermined threshold value which is obtained by experimentation or determined by an appropriate design theory and by which it can be determined whether the two-way clutch TWC is in the lock mode or not.

For example, a case in which the position M1 as one of the operating positions POSsh is established corresponds to the state in which the two-way clutch TWC is in the lock mode. Further, there is a case in which, although the shift lever 98 is placed in the drive position D as one of the operating positions POSsh, the two-way clutch TWC fails to be switched from the lock mode into the one-way mode and remains in the lock mode, for example, when the vehicle 10 is in the driven state in process of switching of the two-way clutch TWC from the lock mode into the one-way mode. Such a case with a so-called “unlock failure” also corresponds to the state in which the two-way clutch TWC is in the lock mode. The lock-state determining portion 126 determines that the two-way clutch TWC is in the lock mode in these cases when the rotational speed difference ΔNtwc is not larger than the lock-mode determination threshold value α1.

When it is determined by the lock-state determining portion 126 that the two-way clutch TWC is in the lock mode, the shift-up-request determining portion 128 determines whether the shift-up request for establishing the second drive-force transmitting path PT2 in place of the first drive-force transmitting path PT1, namely, switching from the gear running mode to the belt running mode, is made. The shift-up-request determining portion 128 determines that the shift-up request is made when the position M1 has been switched to the position M2 or the drive position D (position D2). Further, when the running state point (that is defined by a combination of the actual values of the running speed V and the accelerator operation amount θacc) has been moved across the shift-up line in the shifting map, for example, by acceleration during the running in the gear running mode with the shift lever 98 being placed in the drive position D (position D1), the shift-up-request determining portion 128 determines that the shift-up request for the switching to the belt running mode (position D2) is made. It is noted that the two-way clutch TWC is switched to the one-way mode when the second drive-force transmitting path PT2 is established in place of the first drive-force transmitting path PT1.

When it is determined by the shift-up-request determining portion 128 that the shift-up request is made, the transmission-shifting control portion 122 causes the first clutch C1 and the second clutch C2 to be released and engaged, respectively, so as to switch from the gear running mode to the belt running mode. Further, when the shift-up request is based on the switching from the position M1 to the position M2 or to the drive position D, the transmission-shifting control portion 122 causes the two-way clutch TWC to be switched from the lock mode to the one-way mode.

When it is determined that the shift-up request is made, the transmission-shifting control portion 122 causes the first clutch C1 to be released. Specifically, when it is determined that the shift-up request is made, the transmission-shifting control portion 122 supplies, to the hydraulic control unit 46, a command requesting the SL1 pressure Psl1 (by which the first clutch C1 is controlled) to be controlled to zero. Further, when it is determined that the shift-up request is made, the transmission-shifting control portion 122 cause the second clutch C2 to wait until a certain condition is satisfied, without causing the second clutch C2 to be engaged. Further, when the shift-up request is based on the switching from the position M1 to the position M2 or to the drive position D, the transmission-shifting control portion 122 supplies, to the hydraulic control unit 46, a command requesting the TWC pressure Ptwc of the hydraulic actuator 41 (by which operation of the two-way clutch TWC is controlled) to be controlled to zero, exactly or substantially at the same time as start of release of the first clutch C1, so as to switch the two-way clutch TWC to the one-way mode from the lock mode.

When it is determined that the shift-up request is made, the C2-engagement-condition determining portion 130 makes a determination as to whether a condition required to start the engagement of the second clutch C2 is satisfied. The C2-engagement-condition determining portion 130 makes this determination, based on whether or not the input-shaft rotational speed Nin of the input shaft 22 corresponding to the turbine rotational speed NT has substantially reached a target rotational speed Nin* that is a target value of the input-shaft rotational speed Nin after the second drive-force transmitting path PT2 is established in place of the first drive-force transmitting path PT1 (after execution of the shift-up action). Specifically, the C2-engagement-condition determining portion 130 determines whether a rotational speed difference ΔNin between the input-shaft rotational speed Nin and the target rotational speed Nin* is equal to or smaller than a threshold value α2. The threshold value α2 is a predetermined threshold value which is obtained by experimentation or determined by an appropriate design theory and by which it can be determined that the input-shaft rotational speed Nin is synchronized with the target rotational speed Nin*. Therefore, when the rotational speed difference ΔNin becomes not larger than the threshold value α2, it is determined that input-shaft rotational speed Nin has reached (been synchronized with) the target rotational speed Nin*. In this instance, the C2-engagement-condition determining portion 130 determines that the condition required to start the engagement of the second clutch C2 is satisfied, and the transmission-shifting control portion 122 causes the second clutch C2 to start to be engaged. In other words, the transmission-shifting control portion 122 causes the second clutch C2 to wait until the rotational speed difference ΔNin becomes not larger than the threshold value α2, without causing the second clutch C2 to be engaged. It is noted that the target rotational speed Nin* is calculated based on the running speed V and a value of the gear ratio γcvt of the continuously variable transmission 24 (normally, the highest gear ratio γmax) after the switching to the belt running mode.

Alternatively, the C2-engagement-condition determining portion 130 makes the determination as to whether the condition required to start the engagement of the second clutch C2 is satisfied or not, based on whether or not a predetermined waiting time tst elapses since the shift-up request is made, namely, based on whether a length of time from a point of time at which the shift-up request is made becomes larger than the predetermined waiting time tst, which corresponds to “predetermined length value” that is recited in the appended claims. The waiting time tst is a length of time which is obtained by experimentation or determined by an appropriate design theory and which is required for the input-shaft rotational speed Nin to reach the target rotational speed Nin* that is a target value of the input-shaft rotational speed Nin after execution of the shift-up action. When the waiting time tst elapses since the shift-up request is made, the C2-engagement-condition determining portion 130 determines that the condition required to start the engagement of the second clutch C2 is satisfied, and the transmission-shifting control portion 122 causes the second clutch C2 to start to be engaged. In other words, the transmission-shifting control portion 122 causes the second clutch C2 to wait until the waiting time tst elapses from the point of time at which the shift-up request is made, without causing the second clutch C2 to be engaged.

Further, while the second clutch C2 is being caused to wait to be engaged, the C2-engagement-condition determining portion 130 determines whether the two-way clutch TWC has been switched to the one-way mode, and determines that the condition required to engage the second clutch C2 is satisfied when determining that the two-way clutch TWC has been switched to the one-way mode. The C2-engagement-condition determining portion 130 determines that the two-way clutch TWC has been switched to the one-way mode, when the rotational speed difference ΔNtwc is equal to or smaller than the lock-mode determination threshold value α1, wherein the rotational speed difference ΔNtwc is the difference (=|Ntwcout−Ntwcin|) between the output rotational speed Ntwcout of the output-side rotary members 70 of the two-way clutch TWC and the input rotational speed Ntwcin of the input-side rotary member 68 of the two-way clutch TWC. When it is determined by the C2-engagement-condition determining portion 130 that the two-way clutch TWC has been switched to the one-way mode, the transmission-shifting control portion 122 causes the second clutch C2 to start to be engaged.

While the second clutch C2 is being caused to wait to be engaged, the acceleration-ON determining portion 132 determines whether the accelerator pedal 45 is operatively depressed by the operator. The acceleration-ON determining portion 132 determines that the accelerator pedal 45 is depressed when the accelerator operation amount θacc becomes larger than a predetermined determination threshold value β while the second clutch C2 is being caused to wait to be engaged. While the second clutch C2 is being caused to wait to be engaged, since the first clutch C1 has been released, the drive-force transmitting apparatus 16 is placed in the neutral state in which the drive force is not transmitted along either the first drive-force transmitting path PT1 or the second drive-force transmitting path PT2. In the neutral sate of the drive-force transmitting apparatus 16, if the accelerator pedal 45 is depressed, there is a risk of racing of the engine 12. In the present embodiment, when it is determined by the acceleration-ON determining portion 132 that the accelerator pedal 45 is depressed, the transmission-shifting control portion 122 causes the second clutch C2 to start to be engaged whereby the second drive-force transmitting path PT2 is established, namely, whereby the second drive-force transmitting path PT2 is placed in a drive-force transmittable state, for thereby restraining the racing of the engine 12.

In a state in which the two-way clutch TWC is not switched to the one-way mode, when the input-shaft rotational speed Nin reaches the target rotational speed Nin*, or when the waiting time tst elapses since the shift-up request is made, the second clutch C2 is engaged with the two-way clutch TWC being in the lock mode. Further, in a state in which the second clutch C2 is being caused to wait to be engaged, when the accelerator pedal 45 is depressed, too, the second clutch C2 is engaged with the two-way clutch TWC being in the lock mode. If the running speed V is increased to a high speed with the belt running mode being established in each of these state, the rotation of the drive wheels 14 rotated at a high speed is transmitted to the first clutch C1 thought the two-way clutch TWC so that there is a risk that the first clutch C1 (drum, etc.) could be rotated at a high speed.

For restraining the first clutch C1 from being rotated at high speed, the engine control portion 120 limits the engine torque Te, i.e., the drive force generated by the engine 12. Specifically, the engine control portion 120 limits the engine torque Te such that the running speed V does not become higher than an upper limit value Vmax. The upper limit value Vmax is a predetermined threshold value which is obtained by experimentation or determined by an appropriate design theory and by which the rotational speed Nc1 of the first clutch C1 (more precisely, a rotational speed of the drum of the first clutch C1 that is connected to the two-way clutch TWC) is held not higher than a predetermined allowable maximum rotational speed Nallow. This allowable maximum rotational speed Nallow is set to a value that avoids reduction of durability of the first clutch C1 which could be caused by high speed rotation of the first clutch C1.

When the running speed V becomes higher than the upper limit value Vmax, for example, the engine control portion 120 reduces the engine torque Te by a predetermined constant value K. Further, when the running speed V is not reduced to the upper limit value Vmax or less even after the engine torque Te has been reduced by the constant value K, the engine control portion 120 further reduces the engine torque Te by the constant value K. Thus, until the running speed V becomes not higher than the upper limit value Vmax, the engine control portion 120 reduces the engine torque Te by the constant value K in a stepped manner. When the running speed V becomes not higher than the upper limit value Vmax, the engine control portion 120 terminates to reduce the engine torque Te. With the engine torque Te being limited as described above, the running speed V is made not higher than the upper limit value Vmax, whereby the rotational speed Nc1 of the first clutch C1 is made not higher than the allowable maximum rotational speed Nallow. Thus, the first clutch C1 is restrained from being rotated at a high speed.

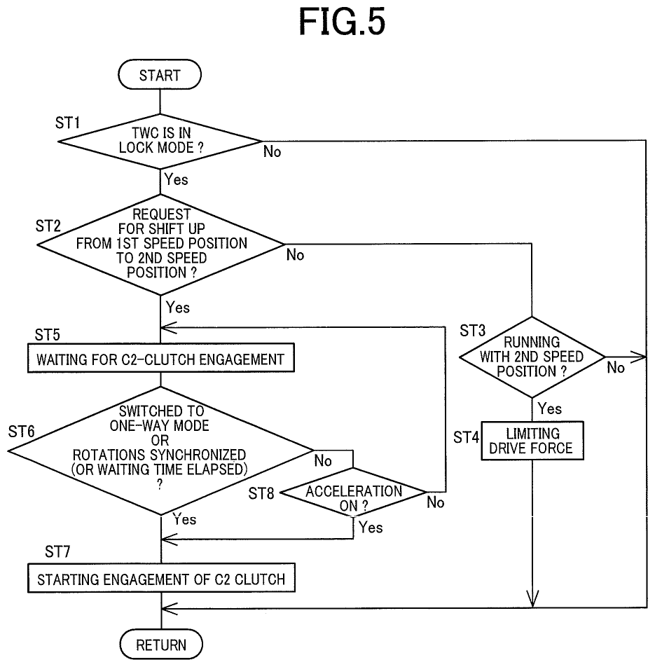

FIG. 5 is a flow chart showing a main part of a control routine executed by the electronic control apparatus 100, namely, a control routine that is executed for restraining the first clutch C1 from being rotated at a high speed even when the two-way clutch TWC fails to be switched to the one-way mode. This control routine is executed in a repeated manner during forward running of the vehicle 10.

The control routine is initiated with step ST1 corresponding to control function of the lock-state determining portion 126, which is implemented to determine whether the two-way clutch TWC is placed in the lock mode or not. When a negative determination is made at step ST1, one cycle of execution of the control routine is completed. When an affirmative determination is made at step ST1, step ST2 corresponding to control function of the shift-up-request determining portion 128 is implemented to determine whether the shift-up request for establishing the second drive-force transmitting path PT2 in place of the first drive-force transmitting path PT1, namely, for establishing the belt running mode (second speed position) in place of the gear running mode (first speed position), is made or not. At this step ST2, it is determined that the shift-up request is made, for example, when the position M1 has been switched to the position M2 or the drive position D, or when the running state point (that is defined by a combination of the actual values of the running speed V and the accelerator operation amount θacc) has been moved across the shift-up line in the shifting map, for example, by acceleration made during the running in the gear running mode with the shift lever 98 being placed in the drive position D (position D1).

When the shift-up request is not made, namely, when a negative determination is made at step ST2, the control flow goes to step ST3 corresponding to control function of the transmission-shifting control portion 122, which is implemented to determine whether the vehicle 10 is currently running with the belt running mode (second speed position) being established or not. When the vehicle 10 is currently running with the gear running mode (first speed position) being established, namely, a negative determination is made at step ST3, one cycle of execution of the control routine is completed. When it is determined that the vehicle 10 is currently running with the belt running mode (second speed position) being established, step ST4 corresponding to control function of the engine control portion 120 is implemented to limit the engine torque Te of the engine 12 such that the running speed V is made not higher than the upper limit value Vmax. Thus, even when the two-way clutch TWC is in the lock mode, the rotational speed Nc1 of the first clutch C1 is made not higher than the allowable maximum rotational speed Nallow whereby the first clutch C1 is restrained from being rotated at a high speed.

When it is determined at step ST2 that the shift-up request is made, step ST5 corresponding to control function of the transmission-shifting control portion 122 is implemented to cause the second clutch C2 to wait to be engaged while causing the first clutch C1 to start to be released. Step ST5 is followed by step ST6 corresponding to control function of the C2-engagement-condition determining portion 130, which is implemented to determine whether the two-way clutch TWC has been switched to the one-way mode or not. Further, at step ST6, it is determined whether the input-shaft rotational speed Nin has reached the target rotational speed Nin* or not (i.e., whether the input-shaft rotational speed Nin has been synchronized with the target rotational speed Nin* or not), or it is determined whether the waiting time tst has elapsed or not since the shift-up request was made.

When the two-way clutch TWC has not been switched to the one-way mode and the input-shaft rotational speed Nin has not reached the target rotational speed Nin*, or when the two-way clutch TWC has not been switched to the one-way mode and the waiting time tst has not elapsed since the shift-up request was made, a negative determination is made at step ST6 and the control flow goes to step ST8. At step ST8 corresponding to control function of the acceleration-ON determining portion 132, it is determined whether the accelerator pedal 45 is depressed by the vehicle operator or not. When a negative determination is made at step ST8, the control flow goes back to step ST5 so that the second clutch C2 is kept waiting. When an affirmative determination is made at step at ST8, the control flow goes to step ST7. Further, at step ST6, when it is determined that the two-way clutch TWC has been switched to the one-way mode or the input-shaft rotational speed Nin has reached the target rotational speed Nin*, or when the two-way clutch TWC has been switched to the one-way mode or the waiting time tst has elapsed since the shift-up request was made, an affirmative determination is made at step ST6 and the control flow goes to step ST7. At step ST7 corresponding to control function of the transmission-shifting control portion 122, the engagement of the second clutch C2 is started.

In a case in which it is determined at step ST6 that the input-shaft rotational speed Nin has reached the target rotational speed Nin* or that the waiting time tst has elapsed since the shift-up request was made, or in a case in which it is determined at step ST8 that the accelerator pedal 45 is depressed, step ST7 is implemented to engage the second clutch C2 with the two-way clutch TWC being placed in the lock mode. In each of these cases in which the control flow goes back to step ST1 after implementation of step ST7, an affirmative determination is made at step ST1 because the two-way clutch TWC is placed in the lock mode, and a negative determination is made at step ST2 because the shift-up request is not made, so that the control flow goes to step ST3. At step ST3, an affirmative determination is made because the second clutch C2 has been engaged to establish the belt running mode (second speed position). Then, step ST4 is implemented to limit the engine torque Te of the engine 12. Thus, the running speed V is made not higher than the upper limit value Vmax, whereby the rotational speed Nc1 of the first clutch C1 is made not higher than the allowable maximum rotational speed Nallow. Thus, the first clutch C1 is restrained from being rotated at a high speed.

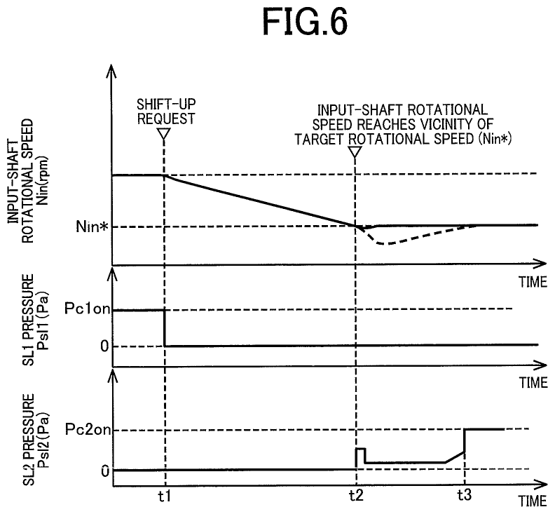

FIG. 6 is a time chart showing a result of the control routine executed through the control functions of the electronic control apparatus 100, namely, a result of the control routine executed as shown in the flow chart of FIG. 5. In FIG. 6, abscissa axes represent an elapsed time, while ordinate axes represent the input-shaft rotational speed Nin, the SL1 pressure Psl1 supplied to control the first clutch C1 and the SL2 pressure Psl2 supplied to control the second clutch C2, respectively (as seen from top to bottom). When the SL1 pressure Psl1 is zero, the first clutch C1 is released. When the SL1 pressure Psl1 is increased to a pressure value Pc1on, the first clutch C1 is placed into the engaged state. When the SL2 pressure Psl2 is zero, the second clutch C2 is released. When the SL2 pressure Psl2 is increased to a pressure value Pc2on, the second clutch C2 is placed into the engaged state. It is noted that each of the SL1 pressure Psl1 and the SL2 pressure Psl2 indicated in FIG. 6 represents a command pressure value, and an actual pressure value of each of the SL1 pressure Psl1 and the SL2 pressure Psl2 follows the command value with a certain delay.

In FIG. 6, at a point t1 of time, it is determined that the position M1 is switched to the position M2 or to the drive position D, or it is determined that the belt running mode is to be established with the two-way clutch TWC being placed in the lock mode, and the SL1 pressure Psl1 (command pressure value) is controlled to zero to release the first clutch C1. Further, although not shown in the time chart of FIG. 6, the TWC pressure Ptwc is also controlled to zero concurrently with starting of the control of the SL1 pressure Psl1, or after a certain length of delay time elapses from the starting of the control of the SL1 pressure Psl1, in a case in which the position M1 has been switched to the position M2 or to drive position D. It is noted that, in a case in which the drive position D has been established already before the point t1 of time, namely, in which the two-way clutch TWC has been placed in the one-way mode already before the point t1 of time, the TWC pressure Ptwc is controlled to zero even before the point t1 of time.

At the point t1 of time, the first clutch C1 starts to be controlled to be released, and the input-shaft rotational speed Nin starts to be reduced. In a stage between the point t1 of time and the point of time t2, the input-shaft rotational speed Nin is reduced toward the target rotational speed Nin* that is the target value of the input-shaft rotational speed Nin after the switching to the belt running mode.

In the stage between the point t1 of time and the point t2 of time, the second clutch C2 is being caused to wait to be engaged. When the two-way clutch TWC is switched to the one-way mode in the stage between the point t1 of time and the point t2 of time, the second clutch C2 starts to be controlled to be engaged, at a point of time at which the two-way clutch TWC is switched to the one-way mode. Further, also when the accelerator pedal 45 is depressed in the stage between the point t1 of time and the point t2 of time, the second clutch C2 is engaged so as to restrain racing of the engine 12.

At the point t2 of time at which it is determined that the rotational speed difference ΔNin between the target rotational speed Nin* and the input-shaft rotational speed Nin becomes not larger than the predetermined threshold value α2, the second clutch C2 starts to be engaged even when the two-way clutch TWC is in the lock mode. Regarding the control for engagement of the second clutch C2, the SL2 pressure Psl2 is temporarily increased (for quick fill) at the point t2 of time. After the temporary increase, the SL2 pressure Psl2 is reduced to a stand-by pressure value, and is then kept in the stand-by value. Then, the SL2 pressure Psl2 is increased toward the pressure value Pc2on, and the engagement of the second clutch C2 is completed at a point t3 of time. Thus, owing to the arrangement in which the engagement of the second clutch C2 is started at the point t2 of time at which it is determined that the input-shaft rotational speed Nin reaches the target rotational speed Nin*, the input-shaft rotational speed Nin is increased toward the target rotational speed Nin* after being reduced below the target rotational speed Nin*, as indicated by broken line after the point t2 of time, whereby uncomfortable feeling given to the vehicle operator is reduced.

Further, although not shown in the time chart of FIG. 6, at the point t3 of time and thereafter, the engine torque Te of the engine 12 is limited such that the running speed V is made not higher than the upper limit value Vmax, whereby the rotational speed Nc1 of the first clutch C1 is made not higher than the allowable maximum rotational speed Nallow. Thus, the first clutch C1 is restrained from being rotated at a high speed.

As described above, in the present embodiment, in a case in which, during forward running of the vehicle 10 with the two-way clutch TWC being placed in the lock mode, the two-way clutch TWC is not switched from the lock mode to the one-way mode even with a request for establishing the second drive-force transmitting path PT2 in place of the first drive-force transmitting path PT1, the second clutch C2 is caused to be engaged, so that it is possible to avoid a long continuation of a neutral state of the drive-force transmitting apparatus 16 in which transmission of the drive force is cut off, thereby reducing uncomfortable feeling that is to be given to the operator. Meanwhile, when the second clutch C2 is engaged with the two-way clutch TWC being in the lock mode, if a running speed of the vehicle 10 is increased, rotation could be transmitted from the drive wheels 14 to the first clutch C1 through the two-way clutch TWC, so that there is a risk that the first clutch C1 could be rotated at a high speed. However, in the present embodiment, the engine torque Te of the engine 12 is limited to limit increase of the running speed V whereby the first clutch C1 can be restrained from being rotated at a high speed.

In the present embodiment, the second clutch C2 is caused to wait until the rotational speed difference ΔNin (between the actual speed value of the input-shaft rotational speed Nin and the target speed value Nin* of the input-shaft rotational speed Nin) becomes not larger than the predetermined threshold value α2, without the second clutch C2 being caused to be engaged until the rotational speed difference ΔNin becomes not larger than the predetermined threshold value α2. Thus, in a case the two-way clutch TWC is switched from the lock mode to the one-way mode while the second clutch C2 is being caused to wait to be engaged, the rotation is not transmitted from the drive wheels 14 to the first clutch C1 after the engagement of the second clutch C2, so that the first clutch C1 is restrained from being rotated at a high speed. Further, since the second clutch C2 is engaged when the input-shaft rotational speed Nin is synchronized with the target rotational speed Nin*, it is possible to reduce shock generated in process of the engagement of the second clutch C2.

In the present embodiment, the second clutch C2 is caused to wait to be engaged until the length of time (from the point of time at which the request for establishing the second drive-force transmitting path PT2 in place of the first drive-force transmitting path PT1 is made) becomes larger than the predetermined waiting time tst, without causing the second clutch C2 to be engaged until the length of time becomes larger than the predetermined waiting time tst. Thus, in a case in which the two-way clutch TWC is switched from the lock mode to the one-way mode while the second clutch C2 is being caused to wait to be engaged, the rotation is not transmitted from the drive wheels 14 to the first clutch C1 after the engagement of the second clutch C2, so that the first clutch C1 is restrained from being rotated at a high speed. Further, since the second clutch C2 is engaged when the length of time (from the point of time at which the request for establishing the second drive-force transmitting path PT2 in place of the first drive-force transmitting path PT1 is made) elapses the predetermined waiting time tst, it is possible to reduce the uncomfortable feeling given to the vehicle operator, owing to the delay of the engagement of the second clutch C2.

In the present embodiment, the second clutch C2 is caused to start to be engaged, when the accelerator pedal 45 of the vehicle 10 is operated while the second clutch C2 is caused to wait to be engaged. Thus, it is possible to restrain racing of the engine 12 in the neutral state of the drive-force transmitting apparatus 16 in which transmission of the drive force is cut off. Further, the second clutch C2 is caused to start to be engaged, when the two-way clutch TWC is switched from the lock mode to the one-way mode while the second clutch C2 is caused to wait to be engaged. Thus, since the two-way clutch TWC has been already switched to the one-way mode when the second clutch C2 is engaged, the first clutch C1 can be restrained from being rotated at a high speed. Further, the second clutch C2 starts to be engaged early, so that it is possible to improve responsiveness for switching to the second drive-force transmitting path PT2.

While the preferred embodiment of this invention has been described in detail by reference to the drawings, it is to be understood that the invention may be otherwise embodied.

For example, in the above-described embodiment, the two-way clutch TWC is constructed to be placed in a selected one of the one-way mode and the lock mode, such that the two-way clutch TWC transmits the drive force during the driving state of the vehicle 10 in the forward running and such that the two-way clutch TWC transmits the drive force during the driving state of the vehicle 10 and during the driven state of the vehicle 10 when the two-way clutch TWC is placed in the lock mode. However, the two-way clutch TWC may be constructed to be placed in a selected one of the plurality of operation modes that include, in addition to the one-way mode and the lock mode, a free mode in which the transmission of the drive force is cut off during the driving state of the vehicle 10 and during the driven state of the vehicle 10.

The construction of the two-way clutch TWC is not necessarily limited to the details described above. For example, the two-way clutch may be constituted by first and second one-way clutches that are provided independently of each other, wherein the first one-way clutch is configured to transmit the drive force acting in the forward-running direction of the vehicle 10, and wherein the second one-way clutch is configured to transmit the drive force acting in the reverse-running direction of the vehicle 10, such that the second one-way clutch is switchable to a cut-off mode in which transmission of the drive force acing in the vehicle reverse-running direction through the second one-way clutch is cut off. Further, the first one-way clutch also may be switchable to a cutting-off mode in which transmission of the drive force acing in the vehicle forward-running direction through the first one-way clutch is cut off. That is, the two-way clutch may be modified in construction as needed, as long as the modified two-way clutch can be placed in a selected one of a plurality of operation modes that include at least the one-way mode and the lock mode.

It is to be understood that the embodiment described above is given for illustrative purpose only, and that the present invention may be embodied with various modifications and improvements which may occur to those skilled in the art.

### NOMENCLATURE OF ELEMENTS

12: engine
14: drive wheels
16: drive-force transmitting apparatus
24: continuously variable transmission
100: electronic control apparatus (control apparatus)
120: engine control portion (control portion)
122: transmission-shifting control portion (control portion)
C1: first clutch
C2: second clutch
TWC: two-way clutch (third clutch)
PT: drive-force transmitting path
PT1: first drive-force transmitting path
PT2: second drive-force transmitting path

What is claimed is:

1. A control apparatus for a drive-force transmitting apparatus that is to be provided in a vehicle having an engine and drive wheels,
wherein the drive-force transmitting apparatus includes a continuously variable transmission, a first clutch, a second clutch and a third clutch, and defines first and second drive-force transmitting paths that are provided in parallel with each other between the engine and the drive wheels, such that the first clutch and the third clutch are provided in the first drive-force transmitting path, and such that the continuously variable transmission and the second clutch are provided in the second drive-force transmitting path,
wherein the first drive-force transmitting path is to be established by engagement of the first clutch and release of the second clutch, such that a drive force is to be transmitted along the first drive-force transmitting path through the first clutch and the third clutch when the first drive-force transmitting path is established,
wherein the second drive-force transmitting path is to be established by release of the first clutch and engagement of the second clutch, such that the drive force is to be transmitted along the second drive-force transmitting path through the continuously variable transmission and the second clutch when the second drive-force transmitting path is established,
wherein the third clutch is a two-way clutch that is to be placed in a selected one of a plurality of operation modes that include at least an one-way mode and a lock mode, such that the two-way clutch is configured to transmit the drive force during a driving state of the vehicle and to cut off transmission of the drive force during a driven state of the vehicle when the two-way clutch is placed in the one-way mode, and such that the two-way clutch is configured to transmit the drive force during the driving state of the vehicle and during the driven state of the vehicle when the two-way clutch is placed in the lock mode,
wherein said control apparatus includes a control portion which is configured to switch the two-way clutch from the lock mode to the one-way mode, when the second drive-force transmitting path is to be established in place of the first drive-force transmitting path, and
wherein, in a case in which, during forward running of the vehicle with the two-way clutch being placed in the lock mode, the two-way clutch is not switched from the lock mode to the one-way mode even with a request for establishing the second drive-force transmitting path in place of the first drive-force transmitting path, said control portion is configured to cause the second clutch to be engaged and to limit the drive force of the engine.

2. The control apparatus according to claim 1,
wherein said control portion is configured to control the second clutch, depending on a rotational speed difference of an actual speed value of an input-shaft rotational speed of an input shaft that is common to the first and second drive-force transmitting paths, relative to a target speed value that is a speed value of the input-shaft rotational speed of the input shaft after the second drive-force transmitting path is established in place of the first drive-force transmitting path, and
wherein said control portion is configured to cause the second clutch to wait to be engaged until the rotational speed difference becomes not larger than a predetermined threshold value, without causing the second clutch to be engaged until the rotational speed difference becomes not larger than the predetermined threshold value.

3. The control apparatus according to claim 1,
wherein said control portion is configured to control the second clutch, depending on a length of time from a point of time at which the request for establishing the second drive-force transmitting path in place of the first drive-force transmitting path is made, and
wherein said control portion is configured to cause the second clutch to wait to be engaged until the length of time becomes larger than a predetermined length value, without causing the second clutch to be engaged until the length of time becomes larger than the predetermined length value.

4. The control apparatus according to claim 2,
wherein said control portion is configured, while causing the second clutch to wait to be engaged, to cause the second clutch to start to be engaged when an accelerator pedal of the vehicle is operated.

5. The control apparatus according to claim 2,
wherein said control portion is configured, while causing the second clutch to wait to be engaged, to cause the second clutch to start to be engaged when the two-way clutch is switched from the lock mode to the one-way mode.

6. The control apparatus according to claim 1,
wherein the two-way clutch includes an input-side rotary portion and an output-side rotary portion such that rotation is to be transmitted between the engine and the input-side rotary portion along the first drive-force transmitting path and such that rotation is to be transmitted between the output-side rotary portion and the drive wheels along the first drive-force transmitting path,
wherein the input-side rotary portion is inhibited from being rotated in a predetermined one of opposite directions relative to the output-side rotary portion and is allowed to be rotated in the other of the opposite directions relative to the output-side rotary portion, when the two-way clutch is placed in the one-way mode, and
wherein the input-side rotary portion is inhibited from being rotated in both of the opposite directions relative to the output-side rotary portion, when the two-way clutch is placed in the lock mode.

7. The control apparatus according to claim 6, further comprising:
a lock-state determining portion configured, during forward running of the vehicle, to determine whether the two-way clutch is placed in the lock mode, based on a rotational speed difference between a rotational speed of the input-side rotary portion and a rotational speed of the output-side rotary portion,
wherein said lock-state determining portion is configured to determine that the two-way clutch is placed in the lock mode, when the rotational speed difference is not larger than a predetermined threshold value.

8. The control apparatus according to claim 1,
wherein the two-way clutch is provided between the first clutch and the drive wheels in the first drive-force transmitting path.
